(19) United States
(12) Patent Application Publication
(10) Pub. No.: US 2019/0330496 A1
(43) Pub. Date: Oct. 31, 2019

(54) MEMBRANE ELECTRODE ASSEMBLY COMPONENT AND METHOD OF MAKING AN ASSEMBLY

(71) Applicant: 3M INNOVATIVE PROPERTIES COMPANY, St. Paul, MN (US)

(72) Inventors: Tatsuo FUKUSHI, Oakdale, MN (US); Michael A. YANDRASITS, Hastings, MN (US); Gregory M. HAUGEN, Edina, MN (US)

(21) Appl. No.: 16/310,247

(22) PCT Filed: Jun. 15, 2017
(86) PCT No.: PCT/US2017/037604

§ 371 Date: Dec. 14, 2018

Related U.S. Application Data
(60) Provisional application No. 62/350,596, filed on Jun. 15, 2016.

(51) Int. Cl. C09J 7/38; C09J 5/00; C09J 11/06; H01M 8/1004; H01M 8/0284; H01M 8/0286

(52) U.S. Cl. CPC C09J 7/381; C09J 5/00; C09J 11/06; H01M 8/1004; C09J 2427/00; H01M 8/0286; C09J 2203/326; C09J 2203/33; C09J 2205/102; H01M 8/0284

(57) ABSTRACT

The method includes providing a component of an assembly having an interior portion and a peripheral portion and adhering separate strips of an adhesive tape to the peripheral portion of the component to surround the interior portion. The short side of a first strip is positioned adjacent a second strip. The adhesive tape includes an adhesive disposed on a backing, and the adhesive includes an amorphous fluoropolymer. The method further includes applying at least one of heat or pressure to the separate strips such that the adhesive flows seals any gap between the first and second strips and crosslinks. The method can be useful, for example, when the assembly is an electrochemical cell assembly and when the component includes at least one of an electrolyte membrane or a current collector.

### CROSS-REFERENCE TO RELATED APPLICATION

This application claims priority to U.S. Provisional Application No. 62/350,596, filed Jun. 15, 2016, the disclosure of which is incorporated by reference in its entirety herein.

### BACKGROUND

Gaskets are useful for providing seals between two different components in a variety of articles. For example, a conventional proton exchange membrane (PEM) fuel cell requires two flow field plates, an anode flow field plate and a cathode flow field plate. A membrane electrode assembly (MEA) including the actual proton exchange membrane is provided between the two flow field plates. Additionally, a gas diffusion media or layer (GDM/GDL) is sandwiched between each flow field plate and the proton exchange membrane. The gas diffusion media enables diffusion of an appropriate gas, either the fuel or the oxidant, to the surface of the proton exchange membrane, while at the same time providing conduction of electricity between the associated flow field plate and the PEM. The GDL may also be called a fluid transport layer (FTL) or a diffuser/current collector (DCC). This type of a basic cell structure itself requires two seals, with each seal being provided between one of the flow field plates and the PEM. Gaskets in fuel cell stack assemblies can be useful for preventing pressurized gas leaking from a MEA during use and also reducing the risk of over-compressing the MEA during manufacturing.

Fluoroelastomers have been reported to be useful as gaskets between a flow field plates in a fuel cell. See, for example, U.S. Pat. No. 7,569,299 (Thompson); U.S. Pat. No. 7,309,068 (Segawa); U.S. Pat. No. 6,720,103 (Nagai), U.S Pat. Appl. Pub. No. 2014/0077462 (Hong), and Japanese Patent No. 5162990, published Mar. 13, 2013. Fluoroelastomer gaskets typically have been prepared by molding (e.g., injection molding) uncured amorphous fluoropolymers.

### SUMMARY

Manufacturing gaskets for use in assemblies (e.g., hard disk drive assemblies, semiconductor devices, and electrode assemblies including battery and fuel cell assemblies) is generally carried out in one of two ways. In a first technique, an individual gasket can be formed by molding it in a suitable mold. With this method, the designer advantageously has freedom in choosing the cross-section of each gasket, which does not have to have a uniform thickness. However, molding gaskets can be relatively complex and expensive, and for each fuel cell configuration, design and manufacture of a mold corresponding exactly to the shape of the associated grooves in the flow field plates would be required.

In a second technique, each gasket is cut from a solid sheet of material. This is a cheaper and less complex technique than molding, in which it is simply necessary to define the shape of the gasket in a plan view and to manufacture a cutting tool of that configuration. The gasket can then be cut from a sheet of appropriate material and thickness. Generally, it is practical to use this method to form gaskets having uniform thickness. Disadvantageously, die-cutting gaskets leads to considerable waste of material. For example, in the gasket shown in FIG. 1, at least the material surrounded by the gasket becomes waste. In some cases, about 80% to 90% of the sheet of material is thrown away after die-cutting.

We now disclose that a gasket having the same shape as the die-cut gasket can be made using separate pieces of material (e.g., adhesive tape) as shown in FIGS. 2 and 3, which would result in significant waste and cost reduction. However, a potential problem for a gasket formed with separate strips of adhesive tape is that gas leaking could occur from the gaps between the separate strips of tape. We have now found that when the adhesive tape includes an amorphous fluoropolymer, applying at least one of heat or pressure to the adhesive tape can allow the adhesive to flow into and seal the gaps between the separate strips of adhesive tape. Thus, we have found that useful gaskets can be made from separate strips of tape without introducing the problem of gas leaking.

In one aspect, the present disclosure provides a method of making an assembly. The method includes providing a component of an assembly having an interior portion and a peripheral portion and adhering separate strips of an adhesive tape to the peripheral portion of the component to surround the interior portion. The short side of a first strip is positioned adjacent a second strip. The adhesive tape includes an adhesive disposed on a backing, and the adhesive includes an amorphous fluoropolymer. The method further includes applying at least one of heat or pressure to the separate strips such that the adhesive seals any gap between the first and second strips and crosslinks. The method can be useful, for example, when the assembly is a fuel cell assembly and when the component includes at least one of an electrolyte membrane or a gas diffusion layer. The method can also be useful, for example, for hard disk drive assemblies, semiconductor devices, and other electrode assemblies including electrolyzers and battery assemblies.

In another aspect, the present disclosure provides component of an assembly (e.g., a membrane electrode assembly) having an interior portion and a peripheral portion with separate strips of a tape backing having first surfaces adhered to the peripheral portion of the component to surround the interior portion. The component can include at least one of an electrolyte membrane or a current collector. The short side of a first strip of the tape backing is positioned adjacent a second strip of the tape backing. An adhesive disposed on the first surfaces of the separate strips of the tape backing seals a gap between the first and second strips of tape backing and adheres the separate strips to the peripheral portion of the component. The adhesive includes a crosslinked amorphous fluoropolymer. The component can be useful, for example, in a fuel cell assembly or subassembly. The component can also be useful, for example, for hard disk drive assemblies, semiconductor devices, and other electrode assemblies including electrolyzers and battery assemblies.

In another aspect, the present disclosure provides a component of an assembly (e.g., a membrane electrode assembly) having an interior portion and a peripheral portion with separate adhesive strips disposed on the peripheral portion of the component to surround the interior portion. The component can include at least one of an electrolyte membrane or a current collector. A short side of a first adhesive strip is positioned adjacent a second adhesive strip. Each of the separate adhesive strips includes an adhesive that includes an amorphous fluoropolymer. Generally, in this aspect, the present disclosure provides a component of a membrane electrode assembly with separate adhesive strips disposed thereon before the adhesive is crosslinked. The component can be useful for making a fuel cell assembly or subassembly. The component can also be useful, for example, for hard disk drive assemblies, semiconductor devices, and other electrode assemblies including electrolyzers and battery assemblies.

In another aspect, the present disclosure provides an electrochemical cell made by the method described above and/or including the component described above.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” and “curable” joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### BRIEF DESCRIPTION OF THE DRAWINGS

FIG. 1 is a plan view of a die cut gasket useful, for example, in membrane electrode assemblies;

FIG. 2 is a plan view of an embodiment of a configuration of adhesive strips useful in the assemblies and methods according to the present disclosure;

FIG. 3 is a plan view of another embodiment of a configuration of adhesive strips useful in the assemblies and methods according to the present disclosure;

FIG. 4A is cross-section taken at line 4A-4A in FIG. 2, showing one embodiment of adhesive strips before the adhesive is cured;

FIG. 4B is cross-section taken at line 4A-4A in FIG. 2, showing the adhesive strips in FIG. 4A after the adhesive is cured; and

FIG. 5 is an exploded perspective view of a fuel cell including adhesive strips in accordance with some embodiments of the present disclosure.

While the present disclosure is amenable to various modifications and alternative forms, specifics thereof have been shown by way of example in the drawings and will be described in detail. It is to be understood, however, that the intention is not to limit the present disclosure to the particular embodiments described. On the contrary, the intention is to cover all modifications, equivalents, and alternatives falling within the scope defined by the appended claims.

### DETAILED DESCRIPTION

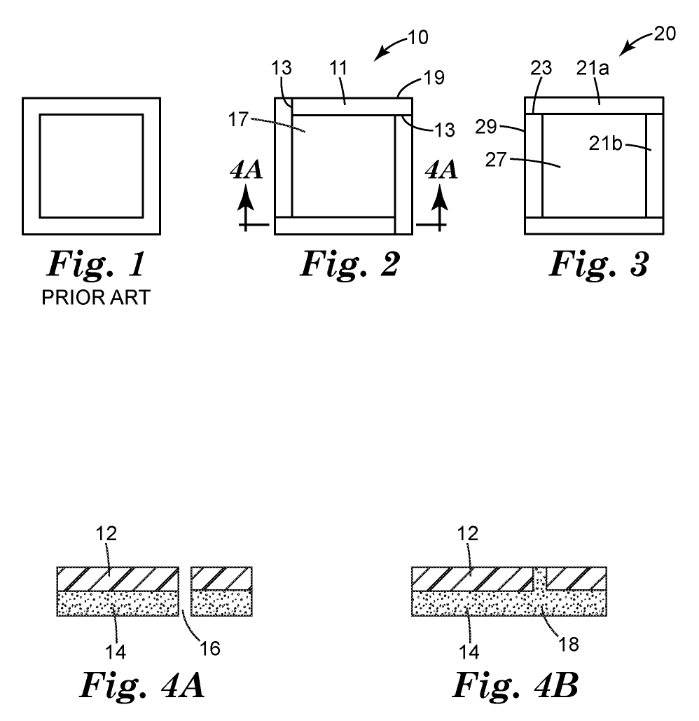

FIGS. 2 and 3 illustrate embodiments of configurations of adhesive strips useful in the components and methods according to the present disclosure. In FIGS. 2 and 3, four strips 11, 21 are used to define the shape of a gasket. The strips 11, 21 collectively surround openings 17, 27. As described above, when a gasket is die-cut from a sheet of material as shown in FIG. 1, the material cut to form the opening is typically thrown away as waste.

In the embodiment illustrated in FIG. 2, strips 11 are rectangular in shape and each have the same size or approximately the same size. Each strip 11 has two opposing short sides 13 and two opposing long borders. Since the strips are rectangular, the long borders are referred to as long sides 19. The short sides 13 of the strips 11 are each cut at 90 degree angles to the long sides 19 of the strips. Also, the short sides 13 of two adjacent strips 11 are at 90 degree angles to each other.

In the embodiment illustrated in FIG. 3, strips 21a and 21b are rectangular in shape, but strips 21a are longer than strips 21b. Each strip 21a, 21b has two opposing short sides 23 and two opposing long sides 29. The short sides 23 of the strips 21a, 21b are each cut at 90 degree angles to the long sides of the strips.

It should be understood from the figures and the description herein that the separate strips are not two concentric gaskets each surrounding the interior portion. The separate strips 11, 21a, 21b do not individually surround the opening 17, 27 but instead collectively surround the opening 17, 27, each forming only a portion of the perimeter of a figure or covering only a portion of the perimeter of a component of an assembly. The separate strips may be understood to collectively form a single gasket. Each of the separate strips itself does not have an aperture and is incapable of surrounding an interior portion of the component of the assembly. Each strip 11, 21a, 21b in the separate strips is typically identical in composition (e.g., may have the same backing and same adhesive disposed on the backing as described in some of the embodiments that follow).

To form a gasket, it is desirable to place the strips 11 and 21a, 21b as close together as possible. It may not be possible to place them close enough to prevent the leakage of gas without overlapping the ends causing variations in thickness in the gasket. Even if the strips are touching, the break between the strips would typically be large enough to allow leakage of gas. Thus, there is typically a gap between two adjacent adhesive strips, which may or may not be touching. The gap may be small enough to be referred to as an interstice. The cross-sectional view of FIG. 4A, taken through line 4A-4A of one embodiment of FIG. 2, illustrates this gap 16. The gap 16 is shown out of scale in FIG. 4A to make it easily visible.

One embodiment of an adhesive strip useful in the components and methods according to the present disclosure is shown in FIG. 4A. The adhesive strip includes a tape backing 12 having first and second opposing major surfaces. First and second major surfaces should be understood to be the surfaces of the tape backing having the greatest surface area. Adhesive 14 is disposed on the first major surface of the tape backing. Referring again to FIG. 2, the gap 16 is shown between the short side 13 of one adhesive strip 11 and the long side 19 of an adjacent adhesive strip.

The size of the gap between separate strips in the components and methods according to the present disclose may depend on the size of the adhesives strips and the equipment used for positioning the adhesive strips to form a gasket. In some embodiments, the gaps between adhesive strips or strips of tape backing can be up to 1 millimeter, up to 500 micrometers, up to 250 micrometers, up to 100 micrometers, up to 50 micrometers, up to 25 micrometers, up to 10 micrometers, or up to 1 micrometer. In some embodiments, the adhesive strips are positioned to touch but still have a gap or interstice between them.

FIG. 4B illustrates the cross-section shown in FIG. 4A after applying at least one of heat or pressure to the adhesive tape such that the adhesive 14 flows into and seals the spaces 16 between the separate strips of the tape backing 12. As described in further detail, below, after the adhesive flows into and seals the gaps and crosslinks, the sealed gap 18 can prevent the leakage of gas.

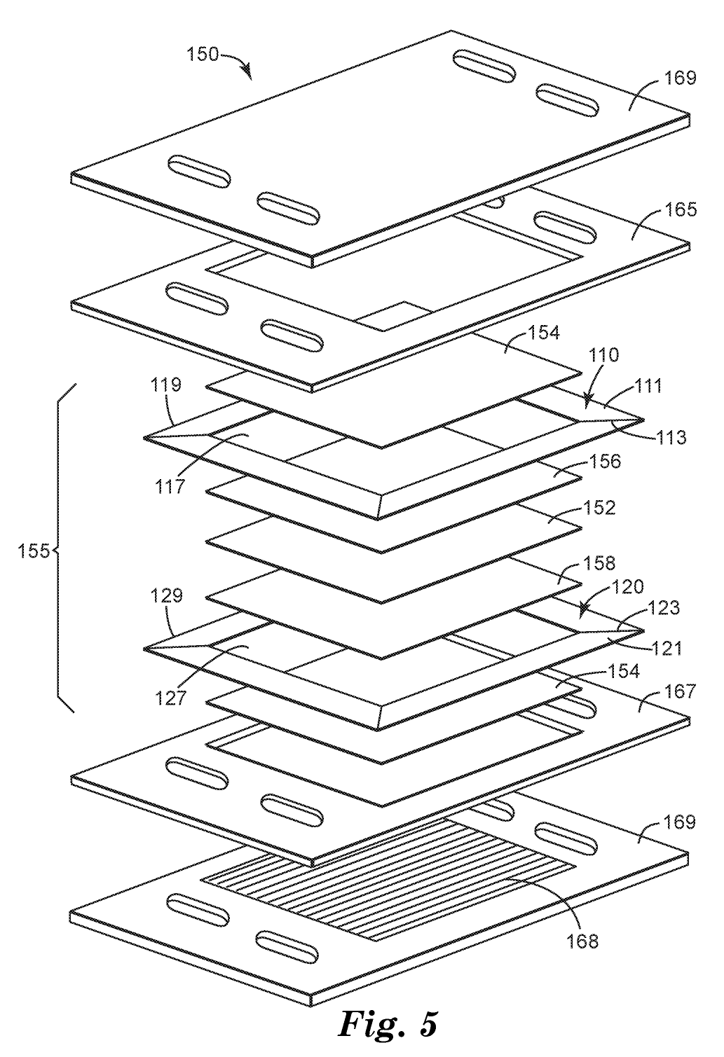

Although the adhesive strips 11, 21a, 21b shown in FIGS. 2 and 3 are configured to form squares, the adhesive strips may be arranged into any shape. For example, the adhesive strips may be arranged to form a rectangle as shown in FIG. 5 or a triangle, pentagon, hexagon, octagon, or other multi-sided figure. Each of these shapes may be made with strips having polygonal shapes (e.g., quadrilaterals such as rectangles, trapezoids, and parallelograms). Separate strips forming two sides of a gasket may also be useful. For example, L-shaped strips or other strips defining an acute or obtuse angle may be useful. The adhesive strips may be arranged to form a shape having non-linear borders, such as a circle or ellipse. In these cases, the strips may have non-linear shapes such as arches (e.g., semi-circular arch, segmental arch, pointed arch, elliptical arch, or parabolic arch). In these embodiments, the long borders of the strips are non-linear (e.g., arcs). For embodiments in which the adhesive strips are in the shape of semi-circular arches, it is envisioned that only two of such strips, positioned short end to short end are necessary to surround an interior portion of a component of an assembly described herein. Strips including angles or arcs may be die cut from a sheet of material but may still produce less waste than a die-cut gasket such as that shown in FIG. 1 since the separate strips do not have an enclosed interior.

In some embodiments (e.g., for L-shaped strips or strips in the shape of arches), there can be two separate strips of adhesive tape adhered to the peripheral portion of the component to surround the interior portion. In some embodiments, there are at least three of the separate strips of the adhesive tape adhered to the peripheral portion of the component to surround the interior portion. In some embodiments, there are at least four of the separate strips of the adhesive tape adhered to the peripheral portion of the component to surround the interior portion. In these embodiments, as shown in FIGS. 2 and 3, each one of the at least three or four separate strips is adjacent two other of the at least three or four separate strips.

The method and component of the present disclosure may be useful, for example, when the interior portion of the component is relatively large. As the size of the interior portion of the component increases, the amount of waste produced when die-cutting a gasket also increases. The method and assembly component of the present disclosure may be useful, for example, when the interior portion of the component has a surface area of at least 500 cm², at least 750 cm², or at least 1000 cm². The interior portion of the component can be considered the active portion of the component (e.g., electrolyte membrane or current collector).

In some embodiments, the assembly of the present disclosure or made by a method of the present disclosure is a membrane electrode assembly in a fuel cell. A typical fuel cell system includes a power section in which one or more fuel cells generate electrical power. A fuel cell is an energy conversion device that converts hydrogen or other fuel and oxygen into water or water and carbon dioxide, producing electricity and heat in the process. Each fuel cell unit may include a proton exchange member (PEM) with gas diffusion layers, which function as diffusers and current collectors, on either side of the proton exchange member. Anode and cathode catalyst layers are respectively positioned between the gas diffusion layers and the PEM. This unit is referred to as a membrane electrode assembly (MEA). Separator plates (also referred to herein and flow field plates or bipolar plates) are respectively positioned on the outside of the gas diffusion layers of the membrane electrode assembly. This type of fuel cell is often referred to as a PEM fuel cell.

The reaction in a single MEA typically produces less than one volt. Therefore, to obtain operating voltages useful in most applications, a plurality of the MEAs may be stacked and electrically connected in series to achieve a desired voltage. Electrical current is collected from the fuel cell stack and used to drive a load. Fuel cells may be used to supply power for a variety of applications, ranging from automobiles to laptop computers.

The efficiency of the fuel cell power system depends on the flow of reactant gases across the surfaces of the MEA as well as the integrity of the various contacting and sealing interfaces within individual fuel cells of the fuel cell stack. Such contacting and sealing interfaces include those associated with the transport of fuels, coolants, and effluents within and between fuel cells of the stack. Proper sealing of fuel cell components and assemblies within a fuel cell stack facilitates efficient operation of the fuel cell system.

A subgasket may be deployed on the electrolyte membrane of a fuel cell, for example, to seal the active regions of the fuel cell and to provide dimensional stability to the electrolyte membrane. Under pressure, the edges of fuel cell components in the stack can cause local stress concentrations on the membrane which may cause failure of the fuel cell. Subgaskets provide support to the membranes to reduce the occurrence of this failure mechanism.

FIG. 5 shows an exploded diagram of an embodiment of an assembly of the present disclosure or made by the method of the present disclosure. As is shown in FIG. 5, a membrane electrode assembly (MEA) 155 of the fuel cell 150 includes five component layers. An electrolyte membrane layer 152 is sandwiched between a pair of GDLs 154. An anode catalyst layer 156 is situated between a first GDL 154 and the membrane 152, and a cathode catalyst layer 158 is situated between the membrane 152 and a second GDL 154. Subgasket 110, formed from a first set of separate adhesive strips, is situated between GDL 154 and the anode catalyst layer 156, and subgasket 120, formed from a second set of separate adhesive strips, is situated between the second GDL 154 and the cathode catalyst layer 158.

In the embodiment illustrated in FIG. 5, separate strips 111, 121 are trapezoidal in shape. Each strip 111, 121 has two opposing short sides 113, 123 and two opposing long sides 119, 129. The short sides 113, 123 of the strips 111, 121 are each cut at 45 degree angles to the long sides 119, 129 of the strips. Also, the short sides 113, 123 of two adjacent strips 111, 121 are at 45 degree angles to each other. Although in the illustrated embodiment the strips are trapezoidal in shape, any of the shapes and configurations of adhesive strips described above and shown in FIGS. 2 and 3 may be useful.

In some embodiments, a membrane layer 152 is fabricated to include an anode catalyst layer 156 as a coating on one surface and a cathode catalyst layer 158 as a coating on the other surface. This structure is often referred to as a catalyst-coated membrane or CCM. The GDLs 154 can be fabricated to include or exclude a catalyst coating. In one configuration, an anode catalyst coating can be disposed partially on the first GDL 154 and partially on one surface of the membrane 152, and/or a cathode catalyst coating can be disposed partially on the second GDL 154 and partially on the other surface of the membrane 152.

The electrolyte membrane is one of the more expensive components of an MEA, and it is sometimes desirable to decrease the amount of electrolyte membrane used to form fuel cell assemblies, thereby decreasing the cost of the fuel cell stacks. Techniques for decreasing the amount of electrolyte membrane used in an MEA is sometimes referred to as “membrane thrifting.” One technique for membrane thrifting is to reduce the x and/or y dimensions of the electrolyte membrane. In the illustrated embodiment, electrolyte membrane 152 is “thrifted” in the x and y directions which means that electrolyte membrane extends only partially under the subgaskets 110, 120.

In FIG. 5, subgaskets 110 and 120 are the same size. In other embodiments, subgasket 110 may the same size or a different size from the subgasket 120. If subgaskets 110 and 120 are the same size, as depicted in FIG. 5, then the outer edges of each of the separate strips 111 aligns with corresponding outer edges of each of the separate strips 121. However if the subgaskets 110 and 120 are not the same size, then one or more outer edges of the separate strips 111 do not align with the corresponding outer edges of the second set of separate strips 121.

The opening 117 defined by separate strips 111 may be the same size or a different size from the opening 127 defined by the second set of separate strips 121. In the embodiment illustrated in FIG. 5, openings 117 and 127 are the same size, and inner edges of the separate strips 111 align with the corresponding inner edges of the second set of separate strips 121. In other embodiments in which the openings 117 and 127 are different sizes, then one or more inner edges of the separate strips 111 do not align with the corresponding inner edges of the second set of separate strips 121.

In the embodiment illustrated in FIG. 5, MEA 155 is shown sandwiched between a first perimeter gasket 165 and a second perimeter gasket 167. Adjacent the first and second perimeter gaskets 165, 167 are flow field plates 169. Each of the flow field plates or separators 169 includes a field of fluid flow channels 168 and ports through which hydrogen and oxygen feed fuels may pass.

In the configuration depicted in FIG. 5, flow field plates 169 are configured as unipolar flow field plates, also referred to as monopolar flow field plates, in which a single MEA 155 is sandwiched therebetween. A unipolar flow field plate may comprise a separator that includes a flow field side and a cooling side. The flow field side incorporates a field of gas flow channels 168 and ports through which hydrogen or oxygen feed fuels may pass. The cooling side incorporates a cooling arrangement, such as integral cooling channels. Alternatively, the cooling side may be configured to contact a separate cooling element, such as a cooling block or bladder through which a coolant passes or a heat sink element, for example.

The perimeter gaskets 165, 167 provide sealing within the fuel cell to isolate the various fluid (gas/liquid) transport and reaction regions from contaminating one another and from inappropriately exiting the fuel cell 150 and may further provide for electrical isolation and/or hard stop compression control between the flow field plates 169. The term “hard stop” generally refers to a nearly or substantially incompressible material that does not significantly change in thickness under operating pressures and temperatures. More particularly, the term “hard stop” refers to a substantially incompressible member or layer in a membrane electrode assembly (MEA) which halts compression of the MEA at a fixed thickness or strain.

The perimeter gaskets 165, 167, may employ one or more gaskets, sub-gaskets and/or o-rings to effect sealing of the edges of the MEA 155 and sealing between and around the MEA 155 and the flow field plates 169. In one configuration, the perimeter gaskets 165, 167 include a gasket system formed from one, two, or more layers of various selected materials employed to provide the requisite sealing within the fuel cell 150. Such materials include, for example, polytetrafluoroethylene, fiberglass impregnated with polytetrafluoroethylene, a variety of crosslinkable resin materials, elastomeric materials, UV curable polymeric material, surface texture material, multi-layered composite material, sealants, and silicon material. Other configurations employ an in-situ formed seal system. In some embodiments, separate strips of an adhesive as described herein can be useful for the perimeter gaskets 165, 167 as well as the subgaskets 110, 120.

Adhesives useful in the components and methods according to the present disclosure include amorphous fluoropolymers. Amorphous fluoropolymers do not exhibit a melting point. They generally have glass transition temperatures below room temperature and exhibit little or no crystallinity at room temperature. Amorphous fluoropolymers useful as polymer processing additives include homopolymers and/or copolymers of fluorinated olefins. In some embodiments, the homopolymers or copolymers can have a fluorine atom-to-carbon atom ratio of at least 1:2, in some embodiments at least 1:1; and/or a fluorine atom-to-hydrogen atom ratio of at least 1:1.5.

Amorphous fluoropolymers useful for practicing the present disclosure can comprise interpolymerized units derived from at least one partially fluorinated or perfluorinated ethylenically unsaturated monomer represented by formula R^{a}CF═CR^{a}₂, wherein each R^{a} is independently fluoro, chloro, bromo, hydrogen, a fluoroalkyl group (e.g. perfluoroalkyl having from 1 to 8, 1 to 4, or 1 to 3 carbon atoms), a fluoroalkoxy group (e.g. perfluoroalkoxy having from 1 to 8, 1 to 4, or 1 to 3 carbon atoms, optionally interrupted by one or more oxygen atoms), alkyl or alkoxy of from 1 to 8 carbon atoms, aryl of from 1 to 8 carbon atoms, or cyclic saturated alkyl of from 1 to 10 carbon atoms. Examples of useful fluorinated monomers represented by formula R^{a}CF═CR^{a}₂ include vinylidene fluoride (VDF), tetrafluoroethylene (TFE), hexafluoropropylene (HFP), chlorotrifluoroethylene, 2-chloropentafluoropropene, dichlorodifluoroethylene, 1,1-dichlorofluoroethylene, 1-hydropentafluoropropylene, 2-hydropentafluoropropylene, perfluoroalkyl perfluorovinyl ethers, and mixtures thereof.

In some embodiments, an amorphous fluoropolymer useful for practicing the present disclosure includes units from one or more monomers independently represented by formula CF₂═CFORf, wherein Rf is perfluoroalkyl having from 1 to 8, 1 to 4, or 1 to 3 carbon atoms, optionally interrupted by one or more —O— groups. Perfluoroalkoxyalkyl vinyl ethers suitable for making an amorphous fluoropolymer include those represented by formula CF₂═CF(OCₙF₂ₙ)_{z}ORf₂, in which each n is independently from 1 to 6, z is 1 or 2, and Rf₂ is a linear or branched perfluoroalkyl group having from 1 to 8 carbon atoms and optionally interrupted by one or more —O— groups. In some embodiments, n is from 1 to 4, or from 1 to 3, or from 2 to 3, or from 2 to 4. In some embodiments, n is 1 or 3. In some embodiments, n is 3. CₙF₂ₙ may be linear or branched. In some embodiments, CₙF₂ₙ can be written as (CF₂)ₙ, which refers to a linear perfluoroalkylene group. In some embodiments, CₙF₂ₙ is —CF₂—CF₂—CF₂—. In some embodiments, CₙF₂ₙ is branched, for example, —CF₂—CF(CF₃)—. In some embodiments, (OCₙF₂ₙ)_{z} is represented by —O—(CF₂)₁₋₄—[O(CF₂)₁₋₄]₀₋₁. In some embodiments, Rf₂ is a linear or branched perfluoroalkyl group having from 1 to 8 (or 1 to 6) carbon atoms that is optionally interrupted by up to 4, 3, or 2 —O— groups. In some embodiments, Rf₂ is a perfluoroalkyl group having from 1 to 4 carbon atoms optionally interrupted by one —O— group. Suitable monomers represented by formula CF₂═CFORf and CF₂═CF(OCₙF₂ₙ)_{z}ORf₂ include perfluoromethyl vinyl ether, perfluoroethyl vinyl ether, perfluoropropyl vinyl ether, CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃₀CF₃, CF₂═CFOCF₂CF₂(OCF₂)₄₀CF₃, CF₂═CFOCF₂CF₂OCF₂OCF₂OCF₃, CF₂═CFOCF₂CF₂OCF₂CF₂CF₃ CF₂═CFOCF₂CF₂OCF₂CF₂OCF₂CF₂CF₃, CF₂═CFOCF₂CF(CF₃)—O—C₃F₇ (PPVE-2), CF₂═CF(OCF₂CF(CF₃))₂—O—C₃F₇ (PPVE-3), and CF₂═CF(OCF₂CF(CF₃))₃—O—C₃F₇ (PPVE-4). Many of these perfluoroalkoxyalkyl vinyl ethers can be prepared according to the methods described in U.S. Pat. No. 6,255,536 (Worm et al.) and U.S. Pat. No. 6,294,627 (Worm et al.).

Perfluoroalkyl alkene ethers and perfluoroalkoxyalkyl alkene ethers may also be useful for making an amorphous polymer for the composition, method, and use according to the present disclosure. In addition, the amorphous fluoropolymers may include interpolymerized units of fluoro (alkene ether) monomers, including those described in U.S. Pat. No. 5,891,965 (Worm et al.) and U.S. Pat. No. 6,255,535 (Schulz et al.). Such monomers include those represented by formula CF₂═CF(CF₂)ₘ—O—R_{f}, wherein m is an integer from 1 to 4, and wherein R_{f} is a linear or branched perfluoroalkylene group that may include oxygen atoms thereby forming additional ether linkages, and wherein R_{f} contains from 1 to 20, in some embodiments from 1 to 10, carbon atoms in the backbone, and wherein Rf also may contain additional terminal unsaturation sites. In some embodiments, m is 1. Examples of suitable fluoro (alkene ether) monomers include perfluoroalkoxyalkyl allyl ethers such as CF₂═CFCF₂—O—CF₃, CF₂═CFCF₂—O—CF₂—O—CF₃, CF₂═CFCF₂—O—CF₂CF₂—O—CF₃, CF₂═CFCF₂—O—CF₂CF₂—O—CF₂—O—CF₂CF₃, CF₂═CFCF₂—O—CF₂CF₂—O—CF₂CF₂CF₂—O—CF₃, CF₂═CFCF₂—O—CF₂CF₂—O—CF₂CF₂—O—CF₂—O—CF₃, CF₂═CFCF₂CF₂—O—CF₂CF₂CF₃. Suitable perfluoroalkoxyalkyl allyl ethers include those represented by formula CF₂═CFCF₂(OCₙF₂ₙ)_{z}ORf₂, in which n, z, and Rf₂ are as defined above in any of the embodiments of perfluoroalkoxyalkyl vinyl ethers. Examples of suitable perfluoroalkoxyalkyl allyl ethers include CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. Many of these perfluoroalkoxyalkyl allyl ethers can be prepared, for example, according to the methods described in U.S. Pat. No. 4,349,650 (Krespan).

An amorphous fluoropolymer useful for practicing the present disclosure may also comprise interpolymerized units derived from the interpolymerization of at least one monomer R^{a}CF═CR^{a}₂ with at least one non-fluorinated, copolymerizable comonomer represented by formula R^{b}₂C═CR^{b}₂, wherein each R^{b} is independently hydrogen, chloro, alkyl having from 1 to 8, 1 to 4, or 1 to 3 carbon atoms, a cyclic saturated alkyl group having from 1 to 10, 1 to 8, or 1 to 4 carbon atoms, or an aryl group of from 1 to 8 carbon atoms. Examples of useful monomers represented by formula R^{b}₂C═CR^{b}₂ include ethylene and propylene. Perfluoro-1,3-dioxoles may also be useful to prepare the amorphous fluoropolymer. Perfluoro-1,3-dioxole monomers and their copolymers are described in U.S. Pat. No. 4,558,141 (Squires).

Examples of useful amorphous copolymers of fluorinated olefins are those derived, for example, from vinylidene fluoride and one or more additional olefins, which may or may not be fluorinated (e.g., represented by formula R^{a}CF═CR^{a}₂ or R^{b}₂C═CR^{b}₂). In some embodiments, useful fluoropolymers include copolymers of vinylidene fluoride with at least one terminally unsaturated fluoromonoolefin represented by formula R^{a}CF═CR^{a}₂ containing at least one fluorine atom on each double-bonded carbon atom. Examples of comonomers that can be useful with vinylidene fluoride include hexafluoropropylene, chlorotrifluoroethylene, 1-hydropentafluoropropylene, and 2-hydropentafluoropropylene. Other examples of amorphous fluoropolymers useful for practicing the present disclosure include copolymers of vinylidene fluoride, tetrafluoroethylene, and hexafluoropropylene or 1- or 2-hydropentafluoropropylene and copolymers of tetrafluoroethylene, propylene, and, optionally, vinylidene fluoride. In some embodiments, the amorphous fluoropolymer is a copolymer of hexafluoropropylene and vinylidene fluoride. In some embodiments, the amorphous fluoropolymer is a copolymer of perfluoropropylene, vinylidene fluoride and tetrafluoroethylene.

Amorphous fluoropolymers including interpolymerized units of VDF and HFP typically have from 30 to 90 percent by weight VDF units and 70 to 10 percent by weight HFP units. Amorphous fluoropolymers including interpolymerized units of TFE and propylene typically have from about 50 to 80 percent by weight TFE units and from 50 to 20 percent by weight propylene units. Amorphous fluoropolymers including interpolymerized units of TFE, VDF, and propylene typically have from about 45 to 80 percent by weight TFE units, 5 to 40 percent by weight VDF units, and from 10 to 25 percent by weight propylene units. Those skilled in the art are capable of selecting specific interpolymerized units at appropriate amounts to form an amorphous fluoropolymer. In some embodiments, polymerized units derived from non-fluorinated olefin monomers are present in the amorphous fluoropolymer at up to 25 mole percent of the fluoropolymer, in some embodiments up to 10 mole percent or up to 3 mole percent. In some embodiments, polymerized units derived from at least one of perfluoroalkyl vinyl ether or perfluoroalkoxyalkyl vinyl ether monomers are present in the amorphous fluoropolymer at up to 50 mole percent of the fluoropolymer, in some embodiments up to 30 mole percent or up to 10 mole percent.

In some embodiments, an amorphous fluoropolymer useful for practicing the present disclosure is a TFE/propylene copolymer, a TFE/propylene/VDF copolymer, a VDF/HFP copolymer, a TFE/VDF/HFP copolymer, a TFE/perfluoromethyl vinyl ether (PMVE) copolymer, a TFE/CF₂═CFOC₃F₇ copolymer, a TFE/CF₂═CFOCF₃/CF₂═CFOC₃F₇ copolymer, a TFE/CF₂═C(OC₂F₅)₂ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/HFP copolymer, a CTFE/VDF copolymer, a TFE/VDF copolymer, a TFE/VDF/PMVE/ethylene copolymer, or a TFE/VDF/CF₂═CFO(CF₂)₃OCF₃ copolymer.

Amorphous fluoropolymers useful for the components and methods according to the present disclosure are capable of being crosslinked. That is, the amorphous fluoropolymer typically has a cure site. The amorphous fluoropolymer can include a chloro, bromo-, or iodo-cure site or a combination thereof. In some embodiments, the amorphous fluoropolymer comprises a bromo- or iodo-cure site. In some of these embodiments, the amorphous fluoropolymer comprises an iodo-cure site. The cure site can be an iodo-, bromo-, or chloro- group chemically bonded at the end of a fluoropolymer chain. The weight percent of elemental iodine, bromine, or chlorine in the amorphous fluoropolymer may range from about 0.2 wt. % to about 2 wt. %, and, in some embodiments, from about 0.3 wt. % to about 1 wt. %. To incorporate a cure site end group into the amorphous fluoropolymer, an iodo-chain transfer agent, a bromo-chain transfer agent, a chloro-chain transfer agent, or any combination thereof can be used in the polymerization process. For example, suitable iodo-chain transfer agents include perfluoroalkyl or chloroperfluoroalkyl groups having 3 to 12 carbon atoms and one or two iodo- groups. Examples of iodo-perfluoro-compounds include 1,3-diiodoperfluoropropane, 1,4-diiodoperfluorobutane, 1,6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutane and mixtures thereof. Suitable bromo-chain transfer agents include perfluoroalkyl or chloroperfluoroalkyl groups having 3 to 12 carbon atoms and one or two bromo-groups.

Chloro-, bromo-, and iodo-cure sites may also be incorporated into the amorphous fluoropolymer by including at least one cure site monomer in the polymerization reaction. Examples of cure site monomers include those of the formula CX₂═CX(Z), wherein each X is independently H or F, and Z is I, Br, or R_{f}—Z, wherein Z is I or Br and R_{f} is a perfluorinated or partially perfluorinated alkylene group optionally containing 0 atoms. In addition, non-fluorinated bromo- or iodo-substituted olefins, e.g., vinyl iodide and allyl iodide, can be used. In some embodiments, the cure site monomers is CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂C₁, or a mixture thereof.

In some embodiments, when the amorphous fluoropolymer is perhalogenated, in some embodiments perfluorinated, typically at least 50 mole percent (mol %) of its interpolymerized units are derived from TFE and/or CTFE, optionally including HFP. The balance of the interpolymerized units of the amorphous fluoropolymer (10 to 50 mol %) is made up of one or more perfluoroalkyl vinyl ethers and/or perfluoroalkoxyalkyl vinyl ethers, and a suitable cure site monomer. When the fluoropolymer is not perfluorinated, it typically contains from about 5 mol % to about 95 mol % of its interpolymerized units derived from TFE, CTFE, and/or HFP, from about 5 mol % to about 90 mol % of its interpolymerized units derived from VDF, ethylene, and/or propylene, up to about 40 mol % of its interpolymerized units derived from a vinyl ether, and from about 0.1 mol % to about 5 mol %, in some embodiments from about 0.3 mol % to about 2 mol %, of a suitable cure site monomer.

The amorphous fluoropolymer presently disclosed is typically prepared by a sequence of steps, which can include polymerization, coagulation, washing, and drying. In some embodiments, an aqueous emulsion polymerization can be carried out continuously under steady-state conditions. In this embodiment, for example, an aqueous emulsion of monomers (e.g., including any of those described above), water, emulsifiers, buffers and catalysts are fed continuously to a stirred reactor under optimum pressure and temperature conditions while the resulting emulsion or suspension is continuously removed. In some embodiments, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The amorphous fluoropolymer can be recovered from the latex by coagulation.

The polymerization is generally conducted in the presence of a free radical initiator system, such as ammonium persulfate. The polymerization reaction may further include other components such as chain transfer agents and complexing agents. The polymerization is generally carried out at a temperature in a range from 10° C. and 100° C., or in a range from 30° C. and 80° C. The polymerization pressure is usually in the range of 0.3 MPa to 30 MPa, and in some embodiments in the range of 2 MPa and 20 MPa.

When conducting emulsion polymerization, perfluorinated or partially fluorinated emulsifiers may be useful. Generally these fluorinated emulsifiers are present in a range from about 0.02% to about 3% by weight with respect to the polymer. Polymer particles produced with a fluorinated emulsifier typically have an average diameter, as determined by dynamic light scattering techniques, in range of about 10 nanometers (nm) to about 300 nm, and in some embodiments in range of about 50 nm to about 200 nm.

Examples of suitable emulsifiers perfluorinated and partially fluorinated emulsifier having the formula [R_{f}—O-L-COO⁻]ᵢXⁱ⁺ wherein L represents a linear partially or fully fluorinated alkylene group or an aliphatic hydrocarbon group, R_{f} represents a linear partially or fully fluorinated aliphatic group or a linear partially or fully fluorinated aliphatic group interrupted with one or more oxygen atoms, Xⁱ⁺ represents a cation having the valence i and i is 1, 2 or 3. (See, e.g. U.S. Pat. No. 2007/0015864 to Hinzter et al.). Additional examples of suitable emulsifiers also include perfluorinated polyether emulsifiers having the formula CF₃—(OCF₂)ₘ—O—CF₂—X, wherein m has a value of 1 to 6 and X represents a carboxylic acid group or salt thereof, and the formula CF₃—O—(CF₂)₃—(OCF(CF₃)—CF₂)_{z}—O-L-Y wherein z has a value of 0, 1, 2 or 3, L represents a divalent linking group selected from —CF(CF₃)—, —CF₂— and —CF₂CF₂— and Y represents a carboxylic acid group or salt thereof (See, e.g., U.S. Pat. Publ. No. 2007/0015865 to Hintzer et al.). Other suitable emulsifiers include perfluorinated polyether emulsifiers having the formula R_{f}—O(CF₂CF₂O)ₘCF₂COOA wherein R_{f} is CₙF_{(2H+1)}; where n is 1 to 4, A is a hydrogen atom, an alkali metal or NH₄, and m is an integer of from 1 to 3. (See, e.g., U.S. Pat. No. 2006/0199898 to Funaki; Hiroshi et al.). Suitable emulsifiers also include perfluorinated emulsifiers having the formula F(CF₂)ₙO(CF₂CF₂₀)ₘCF₂COOA wherein A is a hydrogen atom, an alkali metal or NH₄, n is an integer of from 3 to 10, and m is 0 or an integer of from 1 to 3. (See, e.g. U.S. Pat. Publ. No. 2007/0117915 to Funaki; Hiroshi et al.). Further suitable emulsifiers include fluorinated polyether emulsifiers as described in U.S. Pat. No. 6,429,258 to Morgan et al. and perfluorinated or partially fluorinated alkoxy acids and salts thereof wherein the perfluoroalkyl component of the perfluoroalkoxy has 4 to 12 carbon atoms, or 7 to 12 carbon atoms. (See, e.g. U.S. Pat. No. 4,621,116 to Morgan). Suitable emulsifiers also include partially fluorinated polyether emulsifiers having the formula [R_{f}—(O)ₜ—CHF—(CF₂)ₙ—COO-]ᵢXⁱ⁺ wherein R_{f} represents a partially or fully fluorinated aliphatic group optionally interrupted with one or more oxygen atoms, t is 0 or 1 and n is 0 or 1, Xⁱ⁺ represents a cation having a valence i and i is 1, 2 or 3. (See, e.g. U.S. Pat. Publ. No. 2007/0142541 to Hintzer et al.). Further suitable emulsifiers include perfluorinated or partially fluorinated ether containing emulsifiers as described in U.S. Pat. Publ. Nos. 2006/0223924 to Tsuda; Nobuhiko et al., 2007/0060699 to Tsuda; Nobuhiko et al, 2007/0142513 to Tsuda; Nobuhiko et al and 2006/0281946 to Morita; Shigeru et al. Fluoroalkyl, for example, perfluoroalkyl, carboxylic acids and salts thereof having 6-20 carbon atoms, such as ammonium perfluorooctanoate (APFO) and ammonium perfluorononanoate. (See, e.g. U.S. Pat. No. 2,559,752 to Berry) may also be useful.

If desired, the emulsifiers can be removed or recycled from the fluoropolymer latex as described in U.S. Pat. No. 5,442,097 (Obermeier et al.), U.S. Pat. No. 6,613,941 (Felix et al.), U.S. Pat. No. 6,794,550 (Hintzer et al.), U.S. Pat. No. 6,706,193 (Burkard et al.), and U.S. Pat. No. 7,018,541 (Hintzer et al.).

In some embodiments, the polymerization process may be conducted with no emulsifier (e.g., no fluorinated emulsifier). Polymer particles produced without an emulsifier typically have an average diameter, as determined by dynamic light scattering techniques, in a range of about 40 nm to about 500 nm, typically in range of about 100 nm and about 400 nm, and suspension polymerization will typically produce particles sizes up to several millimeters.

In some embodiments, a water soluble initiator can be useful to start the polymerization process. Salts of peroxy sulfuric acid, such as ammonium persulfate, are typically applied either alone or sometimes in the presence of a reducing agent, such as bisulfites or sulfinates (disclosed in U.S. Pat. No. 5,285,002 Grootaert and U.S. Pat. No. 5,378,782 to Grootaert) or the sodium salt of hydroxy methane sulfinic acid (sold under the trade designation “RONGALIT”, BASF Chemical Company, New Jersey, USA). Most of these initiators and the emulsifiers have an optimum pH-range where they show most efficiency. For this reason, buffers are sometimes useful. Buffers include phosphate, acetate or carbonate buffers or any other acid or base, such as ammonia or alkali metal hydroxides. The concentration range for the initiators and buffers can vary from 0.01% to 5% by weight based on the aqueous polymerization medium.

The chain transfer agents having the cure site and/or the cure site monomers can be fed into the reactor by batch charge or continuously feeding. Because feed amount of chain transfer agent and/or cure site monomer is relatively small compared to the monomer feeds, continuous feeding of small amounts of chain transfer agent and/or cure site monomer into the reactor is difficult to control. Continuous feeding can be achieved by a blend of the iodo-chain transfer agent in one or more monomers. Examples of monomers useful for such a blend include hexafluoropropylene (HFP) and perfluoromethyl vinyl ether (PMVE).

To coagulate the obtained amorphous fluoropolymer latex, any coagulant which is commonly used for coagulation of a fluoropolymer latex may be used, and it may, for example, be a water soluble salt (e.g., calcium chloride, magnesium chloride, aluminum chloride or aluminum nitrate), an acid (e.g., nitric acid, hydrochloric acid or sulfuric acid), or a water-soluble organic liquid (e.g., alcohol or acetone). The amount of the coagulant to be added may be in range of 0.001 to 20 parts by mass, for example, in a range of 0.01 to 10 parts by mass per 100 parts by mass of the amorphous fluoropolymer latex. Alternatively or additionally, the amorphous fluoropolymer latex may be frozen for coagulation.

The coagulated amorphous fluoropolymer can be collected by filtration and washed with water. The washing water may, for example, be ion exchanged water, pure water, or ultrapure water. The amount of the washing water may be from 1 to 5 times by mass to the amorphous fluoropolymer, whereby the amount of the emulsifier attached to the amorphous fluoropolymer can be sufficiently reduced by one washing.

Adjusting, for example, the concentration and activity of the initiator, the concentration of each of the reactive monomers, the temperature, the concentration of the chain transfer agent, and the solvent using techniques known in the art can control the molecular weight of the amorphous fluoropolymer. In some embodiments, amorphous fluoropolymers useful for practicing the present disclosure have weight average molecular weights in a range from 10,000 grams per mole to 200,000 grams per mole. In some embodiments, the weight average molecular weight is at least 15,000, 20,000, 25,000, 30,000, 40,000, or 50,000 grams per mole up to 100,000, 150,000, 160,000, 170,000, 180,000, or up to 190,000 grams per mole. Amorphous fluoropolymers disclosed herein typically have a distribution of molecular weights and compositions. Weight average molecular weights can be measured, for example, by gel permeation chromatography (i.e., size exclusion chromatography) using techniques known to one of skill in the art.

Viscosity of amorphous fluoropolymers typically decreases with decreasing molecular weight. Amorphous fluoropolymers are often described by their Mooney viscosities rather than their molecular weights. Amorphous fluoropolymers useful for practicing the present disclosure may have a Mooney viscosity in a range from 0.1 to 150 (ML 1+10) at 100° C. according to ASTM D1646-06 TYPE A. In some embodiments, amorphous fluoropolymers useful for practicing the present disclosure have a Mooney viscosity in a range from 0.1 to 100, 0.1 to 50, 0.1 to 20, 0.1 to 10, or 0.1 to 5 (ML 1+10) at 100° C. according to ASTM D1646-06 TYPE A.

In some embodiments, the amorphous fluoropolymer useful in the assemblies and methods according to the present disclosure has a storage modulus (GD at 25° C. and 6.3 rad/s of at least 300 kPa and at 25° C. and 0.1 rad/s of up to 200 kPa. In some embodiments, the amorphous fluoropolymer has a storage modulus (GD at 25° C. and 6.3 rad/s of at least 400 kPa and at 25° C. and 0.1 rad/s of up to 100 kPa. In these embodiments, the amorphous fluoropolymer may not be tacky on its own, which may be useful for processing the amorphous fluoropolymer. According to Dahlquist criterion, which indicates that materials having a storage modulus (G′) of less than about 300 kPa at 6.3 rad/s (1 Hz) have pressure sensitive adhesive properties while materials having a G in excess of this value do not. Further details about such amorphous fluoropolymers can be found in U.S. Pat. Appl. Pub. No. 2010/0286329 (Fukushi et al.). In other embodiments, amorphous fluoropolymers useful for practicing the present disclosure having a storage modulus (G′) of less than about 300 kPa at 6.3 rad/s (1 Hz). In these embodiments, the amorphous fluoropolymer may be tacky on its own, which may be beneficial to the adhesion of adhesive tapes in the assemblies and methods disclosed herein.

For crosslinking the amorphous fluoropolymer described above to provide a fluoroelastomer, in some embodiments, the adhesive useful for the assemblies and methods according to the present disclosure includes a peroxide. Typically peroxides useful for practicing the present disclosure are acyl peroxides. Acyl peroxides tend to decompose at lower temperatures than alkyl peroxides and allow for lower temperature curing. In some of these embodiments, the peroxide is di(4-t-butylcyclohexyl)peroxydicarbonate, di(2-phenoxyethyl)peroxydicarbonate, di(2,4-dichlorobenzoyl) peroxide, dilauroyl peroxide, decanoyl peroxide, 1,1,3,3-tetramethylethylbutylperoxy-2-ethylhexanoate, 2,5-dimethyl-2,5-di(2-ethylhexanoylperoxy)hexane, disuccinic acid peroxide, t-hexyl peroxy-2-ethylhexanoate, di(4-methylbenzoyl) peroxide, t-butyl peroxy-2-ethylhexanoate, benzoyl peroxide, t-butylperoxy 2-ethylhexyl carbonate, or t-butylperoxy isopropyl carbonate. In some embodiments, the peroxide is a diacyl peroxide. In some of these embodiments, the peroxide is benzoyl peroxide or a substituted benzoyl peroxide (e.g., di(4-methylbenzoyl) peroxide or di(2,4-dichlorobenzoyl) peroxide). The peroxide is typically present in the adhesive in an amount effective to cure the adhesive. In some embodiments, the peroxide is present in the adhesive in a range from 0.5% by weight to 10% by weight versus the weight of the adhesive. In some embodiments, the peroxide is present in the adhesive in a range from 1% by weight to 5% by weight versus the weight of the adhesive.

In curable amorphous polymer compositions such as those described above, it is often desirable to include a crosslinker. Crosslinkers may be useful, for example, for providing enhanced mechanical strength in the final cured adhesive. Accordingly, in some embodiments, adhesive useful for the assemblies and methods according to the present disclosure further comprises a crosslinker. Those skilled in the art are capable of selecting conventional crosslinkers based on desired physical properties. Examples of useful crosslinkers include tri(methyl)allyl isocyanurate (TMAIC), triallyl isocyanurate (TAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and CH₂═CH—Rₙ—CH═CH₂, wherein R_{f1} is a perfluoroalkylene having from 1 to 8 carbon atoms. The crosslinker is typically present in an amount of 1% by weight to 10% by weight versus the weight of the curable composition. In some embodiments, the crosslinker is present in a range from 2% by weight to 5% by weight versus the weight of the curable composition.

In addition to or instead of the halogen-containing cure site monomers described above, the amorphous fluoropolymer useful in the assemblies and methods disclosed herein may include nitrogen-containing cure sites. These can be incorporated into amorphous fluoropolymers using nitrogen-containing monomers and/or nitrogen-containing chain-transfer agents. Examples of monomers comprising nitrogen-containing groups useful in preparing fluoropolymers comprising a nitrogen-containing cure sites include free-radically polymerizable nitriles, imidates, amidines, amides, imides, and amine-oxides. Mixtures of any of these nitrogen-containing cure sites may be useful in the fluoropolymer compositions according to the present disclosure. Useful nitrogen-containing cure site monomers include nitrile-containing fluorinated olefins and nitrile-containing fluorinated vinyl ethers, for example, CF₂═CFO(CF₂)_{L}CN, CF₂═CFO(CF₂)ₙOCF(CF₃)CN, CF₂═CFO[CF₂CF(CF₃)O]_{q}(CF₂O)_{y}CF(CF₃)CN, or CF₂═CF[OCF₂CF(CF₃)]ᵣO(CF₂)ₜCN, wherein L is in a range from 2 to 12; u is in a range from 2 to 6; q is in a range from 0 to 4; y is in a range from 0 to 6; r is in a range from 1 to 2; and t is in a range from 1 to 4. Examples of such monomers include CF₂═CFO(CF₂)₃OCF(CF₃)CN, perfluoro(8-cyano-5-methyl-3,6-dioxa-1-octene), and CF₂═CFO(CF₂)₅CN. Nitrogen-containing cure sites can also be incorporated into the amorphous fluoropolymer by employing selected chain transfer agents (e.g., I(CF₂)_{d}CN in which d is 1 to 10 or 1 to 6) or by carrying out the free-radical polymerization in the presence of a perfluorosulfinate such as NC(CF₂)_{d}SO₂G, in which G represents a hydrogen atom or a cation with valence of 1 or 2. Nitriles, for example, when heated in the presence of organometallic compounds of arsenic, antimony, and tin and/or organo onium compounds such as those described in U.S. Pat. No. 7,989,552 (Grootaert et al.) can trimerize and form triazine rings to crosslink the amorphous fluoropolymer.

Fluoropolymers, in particular VDF containing amorphous fluoropolymers, may also be cured using a polyhydroxy curing system. In such instance, it will not be required that the fluoropolymer includes cure site components. The polyhydroxy curing system generally comprises one or more polyhydroxy compounds and one or more organo-onium accelerators. The useful organo-onium compounds typically contain at least one heteroatom, i.e., a non-carbon atom such as N, P, S, O, bonded to organic or inorganic moieties. One useful class of quaternary organo-onium compounds broadly comprises relatively positive and relatively negative ions wherein a phosphorus, arsenic, antimony or nitrogen generally comprises the central atom of the positive ion. The negative ion may be an organic or inorganic anion (e.g., halide, sulfate, acetate, phosphate, phosphonate, hydroxide, alkoxide, phenoxide, bisphenoxide, etc.). Examples of useful organo-onium accelerators include those described in U.S. Pat. No. 4,233,421 (Worm), U.S. Pat. No. 4,912,171 (Grootaert et al.), U.S. Pat. No. 5,086,123 (Guenthner et al.), U.S. Pat. No. 5,262,490 (Kolb et al.), and U.S. Pat. No. 5,929,169 (Coggio et al.). In some embodiments, useful organo-onium compounds include those having one or more pendent fluorinated alkyl groups. The polyhydroxy compound may be used in its free or non-salt form or as the anionic portion of a chosen organo-onium accelerator. Examples of useful polyhydroxy compounds for forming cured fluoroelastomers include those disclosed in U.S. Pat. No. 3,876,654 (Pattison) and U.S. Pat. No. 4,233,421 (Worm). In some embodiments, the polyhydroxy compound is an aromatic polyphenol such as 4,4′-hexafluoroisopropylidenyl bisphenol (bisphenol AF), 4,4′-dihydroxydiphenyl sulfone (bisphenol S), and 4,4′-isopropylidenyl bisphenol (bisphenol A).

Fluoropolymers, in particular VDF containing amorphous fluoropolymers, may also be cured using a polyamine curing system. Examples of useful polyamines include N,N-dicinnamylidene-1,6-hexanediamine, trimethylenediamine, cinnamylidene trimethylenediamine, cinnamylidene ethylenediamine, and cinnamylidene hexamethylenediamine Useful polyamines may be protected as carbamates. Examples of useful carbamates are hexamethylenediamine carbamate, bis(4-aminocyclohexyl)methane carbamate, 1,3-diaminopropane monocarbamate, ethylenediamine carbamate and trimethylenediamine carbamate. Usually about 0.1-5 phr of the diamine is used.

In some embodiments, the adhesive useful for the assemblies and methods according to the present disclosure includes a plasticizer. A plasticizer may be useful, for example, for increasing the tackiness of the adhesive. The plasticizer may be an amorphous fluoropolymer incapable of crosslinking, for example. Any of the monomers (other than cure-site monomers) and methods described above may be useful for making such amorphous fluoropolymers. Useful plasticizers can also include perfluoropolyethers such as those described, for example, U.S. Pat. No. 5,268,405 (Ojakaar et al.).

In some embodiments, the plasticizer is an ionic liquid. An ionic liquid is in a liquid state at about 100° C. or less. Ionic liquids typically have negligible vapor pressure and high thermal stability. The ionic liquid is composed of a cation and an anion and typically has a melting point of about 100° C. or less (i.e., it is a liquid at about 100° C. or less), about 95° C. or less, or about 80° C. or less. Certain ionic liquids have melting points that allow them to be in a molten state even at ambient temperature, and therefore they are sometimes referred to as ambient temperature molten salts. The cation and/or anion of the ionic liquid are relatively sterically-bulky, and typically one or both of these ions are an organic ion. The ionic liquid can be synthesized by known methods, for example, by a process such as anion exchange or metathesis process or via an acid-base or neutralization process.

The cation of the ionic liquid may be an ammonium ion, a phosphonium ion, or a sulfonium ion, for example, including various delocalized heteroaromatic cations. Examples of suitable ammonium ions include alkylammonium, imidazolium, pyridinium, pyrrolidinium, pyrrolinium, pyrazinium, pyrimidinium, triazonium, triazinium, quinolinium, isoquinolinium, indolinium, quinoxalinium, piperidinium, oxazolinium, thiazolinium, morpholinium, piperazinium, and combinations thereof. Examples of suitable phosphonium ions include tetraalkylphosphonium, arylphosphonium, alkylarylphosphonium and combinations thereof. Examples of suitable sulfonium ion include alkylsulfonium, arylsulfonium, thiophenium, tetrahydrothiophenium, and combinations thereof. The alkyl group directly bonded to nitrogen atom, phosphorus atom, or sulfur atom may be a linear, branched or cyclic alkyl group having at least 1, 2, or 4 carbon atoms and typically up to 8, 10, 12, 15, or 20 carbon atoms. The alkyl group may optionally contain heteroatoms such as O and N and S in the chain or at the end of the chain (e.g., a terminal —OH group). The aryl group directly bonded to nitrogen atom, phosphorus atom, or sulfur atom may be a monocyclic or condensed cyclic aryl group having at least 5, 6, or 8 carbon atoms and typically up to 12, 15, or 20 carbon atoms. Any of these cations may be further substituted by an alkyl group, an alkenyl group, an alkynyl group, a cycloalkyl group, an aryl group, an aralkyl group, an arylalkyl group, an alkoxy group, an aryloxy group, a hydroxyl group, a carbonyl group, a carboxyl group, an ester group, an acyl group, an amino group, a dialkylamino group, an amide group, an imino group, an imide group, a nitro group, a nitrile group, a sulfide group, a sulfoxide group, a sulfone group, or a halogen atom, and a heteroatom such as oxygen atom, nitrogen atom, sulfur atom and silicon atom may be contained in the main chain or ring of the structure constituting the cation.

Examples of suitable cations include N-ethyl-N′-methylimidazolium, N-methyl-N-propylpiperidinium, N,N,N-trimethyl-N-propylammonium, N-methyl-N,N,N-tripropylammonium, N,N,N-trimethyl-N-butylammoniuim, N,N,N-trimethyl-N-methoxyethylammonium, N-methyl-N,N,N-tris(methoxyethyl)ammonium, N,N-dimethyl-N-butyl-N-methoxyethylammonium, N,N-dimethyl-N,N-dibutylammonium, N-methyl-N,N-dibutyl-N-methoxyethylammonium, N-methyl-N,N,N-tributylammonium, N,N,N-trimethyl-N-hexylammonium, N,N-diethyl-N-methyl-N-(2-methoxyethyl)ammonium, 1-propyl-tetrahydrothiophenium, 1-butyl-tetrahydrothiophenium, 1-pentyl-tetrahydrothiophenium, 1-hexyl-tetrahydrothiophenium, glycidyltrimethylammonium, N-ethylacryloyl-N,N,N-trimethylammonium, N-ethyl-N-methylmorphonium, N,N,N-trioctylammonium, N-methyl-N,N,N-trioctylammonium, N,N-dimethyl-N-octyl-N-(2-hydroxyethyl)ammonium, and combinations thereof.

In some embodiments, the cation does not contain a functional group or reactive moiety (for example, an unsaturated bond). In some of these embodiments, heat resistance of the ionic liquid is maximized. In some embodiments, alkyl and/or aryl groups in the cation are substituted with fluorine atoms, and advantageous compatibility with the amorphous fluoropolymer may result.

The anion of the ionic liquid may be, for example, a sulfate (R—OSO₃—), a sulfonate (R—SO₃—), a carboxylate (R—CO₂—), a phosphate ((RO)₂P(═O)O—), a borate represented by the formula BR₄—, such as tetrafluoroborate (BF₄—) and tetraalkylborate, a phosphate represented by the formula PR₆—, such as hexafluorophosphate (PF₆—) and hexaalkylphosphate, an imide (R₂N—), a methide (R₃C—), nitrate ion (NO₃—), or nitrite ion (NO₂—). In the formulas, each R may be independently a hydrogen atom, a halogen atom (fluorine, chlorine, bromine, iodine), or a substituted or unsubstituted alkyl, alkenyl, alkynyl, cycloalkyl, aryl, aralkyl, arylalkyl, acyl or sulfonyl group. A heteroatom such as an oxygen atom, a nitrogen atom, and a sulfur atom may be contained in the main chain or ring of the group R, and a part or all of hydrogen atoms on the carbon atom of the group R may be replaced with fluorine atoms. In the case where a plurality of R groups are present in the anion, these R groups may be the same or different.

Because of good compatibility with fluoropolymer in general, it is typically advantageous for a part or all of hydrogen atoms on the carbon atom of the group R in the anion to be replaced by fluorine atoms (e.g., a perfluoroalkyl group). Examples of anions containing perfluoroalkyl groups include a bis(perfluoroalkylsulfonyl)imide ((RfSO₂)₂N—), a perfluoroalkylsulfonate (RfSO₃—) and a tris(perfluoroalkylsulfonyl)methide ((RfSO₂)₃C—) (wherein Rf represents a perfluoroalkyl group). The perfluoroalkyl group can include at least 1, 2, 3 or 4 carbon atoms and typically up to 8, 10, 12, 15, or 20 carbon atoms. Examples of suitable bis(perfluoroalkylsulfonyl)imides include bis(trifluoromethanesulfonyl)imide, bis(pentafluoroethanesulfonyl)imide, bis(heptafluoropropanesulfonyl)imide, and bis(nonafluorobutanesulfonyl)imide. Examples of suitable perfluoroalkylsulfonates include trifluoromethanesulfonate, pentafluoroethanesulfonate, heptafluoropropanesulfonate, and nonafluorobutanesulfonate. Examples of suitable tris(perfluoroalkylsulfonyl)methides include tris(trifluoromethanesulfonyl)methide, tris(pentafluoroethanesulfonyl)methide, tris(heptafluoropropanesulfonyl)methide, tris(nonafluorobutanesulfonyl)methide, and a combination thereof.

Specific examples of ionic liquids suitable as plasticizers in the adhesive useful in the assemblies and methods according to the present disclosure include N-methyl-N-propylpiperidinium bis(trifluoromethanesulfonyl)imide, N-methyl-N-propylpiperidinium bis(trifluoromethanesulfonyl)imide, N-ethyl-N′-methylimidazolium bis(trifluoromethanesulfonyl)imide, N,N,N-trimethyl-N-hexylammonium bis(trifluoromethanesulfonyl)imide, and N-methyl-N,N,N-tributylammonium bis(trifluoromethanesulfonyl)imide.

In some embodiments in which the adhesive includes an ionic liquid plasticizer, the absolute value of the solubility parameter difference between amorphous fluoropolymer (δₐ) and ionic liquid (δ_{b}) is less than or equal to 8.2 (MPa)^{1/2} [4 (cal/cc)^{1/2}], in other words, |δₐ−δ_{b}|≤8.2 (MPa)^{1/2}. In some embodiments, the absolute value of the solubility parameter difference between fluoropolymer (δₐ) and ionic liquid (δ_{b}) is less than or equal to 6.1 (MPa)^{1/2} [3 (cal/cc)^{1/2}] or less than or equal to 4.1 (MPa)^{1/2} [2 (cal/cc)^{1/2}]. The solubility parameter of ionic liquids can be calculated using computer simulation. See, for example, Bela Derecskei and Agnes Derecskei-Kovacs, “Molecular modelling simulations to predict density and solubility parameters of ionic liquids”, Molecular Simulation, Vol. 34 (2008) 1167-1175. The solubility parameter, δ, of a fluoroelastomer including VDF and HFP in a 78/22 molar ratio is reported to be 8.7 (cal/cc)^{1/2} (17.8 (MPa)^{1/2}) in Myers and Abu-Isa, Journal of Applied Polymer Science, Vol. 32, 3515-3539 (1986). For the purposes of this application, the solubility parameter of an amorphous fluoropolymer is considered to be 17.8 (MPa)^{1/2}, and the ionic liquid has a solubility parameter in a range from 9.6 (MPa)^{1/2} to 26 (MPa)^{1/2}, in some embodiments, 11.7 (MPa)^{1/2} to 23.9 (MPa)^{1/2}, and in some embodiments, 13.7 (MPa)^{1/2} to 21.9 (MPa)^{1/2}.

Additives such as carbon black, dyes, pigments, stabilizers, lubricants, fillers, and processing aids typically utilized in fluoropolymer compounding can be incorporated into the adhesives useful in the components and methods disclosed herein, provided they have adequate stability for the intended service conditions. Carbon black fillers can be employed in fluoropolymers as a means to balance modulus, tensile strength, elongation, hardness, abrasion resistance, conductivity, and processability of the compositions. Suitable examples include MT blacks (medium thermal black) and large particle size furnace blacks. When used, 1 to 100 parts filler per hundred parts fluoropolymer (phr) of large size particle black is generally sufficient.

Fluoropolymer fillers may also be present in the adhesive. Generally, from 1 to 100 phr of fluoropolymer filler is used. The fluoropolymer filler can be finely divided and easily dispersed as a solid at the highest temperature used in fabrication and curing of the adhesive. By solid, it is meant that the filler material, if partially crystalline, will have a crystalline melting temperature above the processing temperature(s) of the curable composition(s). One way to incorporate fluoropolymer filler is by blending latices. This procedure, using various kinds of fluoropolymer filler, is described in U.S. Pat. No. 6,720,360 to Grootaert et al.

Examples of other fillers that may be useful for balancing modulus, tensile strength, elongation, hardness, abrasion resistance, conductivity, and processability include clay, silica (SiO₂), alumina, iron red, talc, diatomaceous earth, barium sulfate, wollastonite (CaSiO₃), calcium carbonate (CaCO₃), calcium fluoride, titanium oxide, and iron oxide.

Alternatively, in some embodiments, the adhesive useful in the components and methods disclosed herein is free of fillers or contains less than 5%, 2%, or 1% by weight fillers versus the weight of the adhesive. For example, the curable composition according to the present disclosure can be free of inorganic fillers. One advantage to avoiding fillers in the curable compositions disclosed herein is that visible light transmissive adhesives may be obtained, which may be useful for some applications.

Conventional adjuvants may also be incorporated into the adhesive disclosed herein to enhance the properties of the adhesive. For example, acid acceptors may be employed to facilitate the cure and thermal stability of the adhesive. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors can be used in amounts ranging from about 1 to about 20 parts per 100 parts by weight of the amorphous fluoropolymer. However, some applications like fuel cell sealants or gaskets need low metal content because metal ion will deteriorate the proton exchange membrane performance of fuel cell. Accordingly, in some embodiments, the adhesive is free of such adjuvants or includes less than 0.5% by weight of such adjuvants versus the weight of the adhesive.

As described above, the viscosity of an amorphous fluoropolymer generally increases as the molecular weight of the amorphous fluoropolymer increases. Accordingly, amorphous fluoropolymers having relatively low molecular weights can be useful for making adhesives with lower viscosity for coating onto a tape backing to make a tape. In some embodiments, it is also useful to prepare a solution or liquid dispersion containing the amorphous fluoropolymer, the optional plasticizer, catalyst, optional crosslinker, and other components described above. The solution can then be coated onto a tape backing to make an adhesive tape, which dried to remove solvent. Examples of solvents useful for practicing the present disclosure include ketones, esters, carbonates, and formates such as tert-butyl acetate, 4-methyl-2-pentanone, n-butyl acetate, ethyl acetate, 2-butanone, ethyl formate, methyl acetate, cyclohexanone, dimethyl carbonate, acetone, and methyl formate. In some embodiments, the solvent is not an alcohol, which tend to be particularly detrimental to a peroxide-cure.

Compounding can be carried out, for example, on a roll mill (e.g., two-roll mill), internal mixer (e.g., Banbury mixers), or other rubber-mixing device. Thorough mixing is typically desirable to distribute the components and additives uniformly throughout the adhesive composition so that it can cure effectively. The compounding can be carried out in one or several steps. For example, certain components such as the crosslinker may be compounded into a mixture of the amorphous fluoropolymer, solvent, and catalyst just before use. Also the solvent may be compounded into a mixture of the amorphous fluoropolymer, peroxide, and optionally crosslinker in a second step. It is typically desirable that the temperature of the composition during mixing should not rise high enough to initiate curing. For example, the temperature of the composition may be kept at or below about 50° C.

Various substrates may be useful as an adhesive tape backing such as paper or a polymeric film. In some embodiments, the tape backing comprises at least one of a polyamide, a polycarbonate, a modified polyphenylene ether, a polyester, a fluoroplastic, polyphenylene sulfide, polysulfone, polyarylate, polyetherimide, polyimide, polyethersulfone, polyether ketone, or polystyrene. Fluoroplastics useful as tape backings include polytetrafluoroethylene, polychlorotrifluoroethylene, polyvinyl fluoride, polyvinylidene fluoride, tetrafluoroethylene-fluoroalkyl vinyl ether copolymer, tetrafluoroethylene-hexafluoropropylene copolymer, ethylene-tetrafluoroethylene copolymer, ethylene-chlorotrifluoroethylene copolymer, tetrafluoroethylene-perfluorodioxole copolymer, polyvinylidene fluoride-hexafluoropropylene copolymer. In some embodiments, the tape backing includes polytetrafluoroethylene (PTFE). To increase the bonding force of the backing to the adhesive, the backing surface that comes into contact with the adhesive may be subjected to a surface treatment. In some embodiments, the surface treatment may at least partially fluorinate the backing. Examples of the surface treatment which can be used include plasma treatment using a fluorine-containing gas, and coating of a conventional fluorine-containing primer. The plasma treatment using a fluorine-containing gas can be performed, for example, by using octafluoropropane (C₃F₈) as the fluorine-containing gas, using, if desired, tetramethylsilane (TMS) and oxygen in combination, and flowing these gases at a flow rate of 50 to 500 SCCM in WAFR/BATCH 7000 Series manufactured by Plasma-Therm under the conditions of a chamber pressure of 10 to 1,000 mTorr, an output of 50 to 2,000 W and a treatment time of 0.1 to 10 minutes.

In some embodiments, the adhesive disposed on the tape backing is a pressure sensitive adhesive (PSA), and the adhesive tape useful for practicing the present disclosure is a pressure-sensitive adhesive tape. PSAs are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power.

Examples of commercially available tapes suitable for use in the components and methods according to the present disclosure include an adhesive tape with a PTFE backing and a fluoroelastomer adhesive, available under the trade designation, “CIPG 1951” from 3M Company, St. Paul, Minn.

In some embodiments of the adhesive tape useful in the assemblies and methods according to the present disclosure, the amorphous fluoropolymer may be partially cured. That is, before or after the adhesive is coated onto the tape backing, the adhesive composition may be heated to cause partial crosslinking of the amorphous fluoropolymer. The temperature for making a partially cured amorphous fluoropolymer can be selected, for example, based on the decomposition temperature of the peroxide. For example, a temperature can be selected that is above (in some embodiments, at least 10° C., 20° C., or 30° C. above) the ten-hour half-life temperature of the peroxide. The cure time can be selected such that full curing of the amorphous fluoropolymer does not occur. Partial curing of the amorphous fluoropolymer can be useful for modifying its viscoelastic properties to improve the handling or stability of the tape or to increase tackiness, for example.

The method according to the present disclosure includes providing a component of an assembly having an interior portion and a peripheral portion, adhering separate strips of an adhesive tape to the peripheral portion of the component to surround the interior portion, and applying at least one of heat or pressure to the adhesive tape such that the adhesive seals any gaps (described above) between the separate strips of adhesive tape and crosslinks. The adhesive tape can be as described as above in any of its embodiments. Crosslinking the adhesive improves the compression set resistance and other physical properties of the adhesive.

Evidence that the method according to the present disclosure can seal gaps between the separate strips of adhesive is provided in the Examples, below. As shown in Example 1, a cavity was formed in a test apparatus between an aluminum plate, an elastomeric die-cut seal such as that shown in FIG. 1, and a piece of polyimide film. A hole provided in the aluminum plate was connected to an air supply to provide pressure in the cavity. Four separate strips of adhesive tape in a configuration shown in FIG. 2 were applied to the polyimide film according to the method of the present disclosure. Heat and pressure were applied to the adhesive tape to crosslink the adhesive. The polyimide film with the separate strips was then placed on the elastomeric seal in the test apparatus, and a second aluminum plate was clamped on top of the polyimide film. When 275 kPA of air pressure was applied to the cavity, no loss in pressure was observed after 500 seconds. By contrast, when separate strips of the adhesive tape were applied to the polyimide film but not cured with heat and pressure, the pressure decayed to 138 kPa after 400 seconds. Thus, the method of the present disclose can seal gaps between separate strips of adhesive tape prevent gas leakage in an assembly.

Applying at least one of heat or pressure to the adhesive tape such that the adhesive flows and crosslinks, can include heating at a temperature in a range from about 100° C. to 220° C., in some embodiments, from about 110° C. to 180° C., for a period of about 1 minute to about 15 hours, usually for about 1 to 15 minutes. The temperature during cure is sometimes raised gradually from the lower limit of the range to the desired maximum temperature. A pressure of about 100 kilopascal (kPa) to 20,000 kPa, in some embodiments, about 150 kPa to 7000 kPa or about 150 kPa to 1000 kPa, is useful for causing the adhesive to flow.

The adhesive tape useful in the method according to the present disclosure can be a single-sided tape, or an adhesive as described above in any of its embodiments may also be provided on both major surfaces of a tape backing to form a double-sided tape.

Either a double-sided or single-sided tape may be useful in a membrane electrode assembly such as that illustrated in FIG. 5. A single-sided tape may be useful for adhering the tape backing to one of an electrolyte membrane or a gas diffusion layer. However, a double-sided tape may provide a subgasket 110 that can adhere to both the electrolyte membrane 152 and the gas diffusion layer 154. In making a membrane electrode assembly according to the present disclosure, the adhesive tape can be applied to electrolyte membrane, the gas diffusion layer, or both. Either the electrolyte membrane or the gas diffusion layer may be catalyst-coated. A double-sided adhesive tape may be applied between an electrolyte membrane, which may be a catalyst-coated electrolyte membrane, and a gas diffusion layer and cured with at least one of heat or pressure. In any of these embodiments, any gaps between the separate strips of adhesive in the membrane electrode assembly can be sealed with the crosslinked amorphous fluoropolymer.

In some embodiments of the method according to the present disclosure, the method further comprises removing a release liner from the adhesive of the adhesive tape before adhering the separate strips of the adhesive tape to the peripheral portion of the component. A release liner can be a paper liner or polymer film made, for example, from any of the polymers described above for the tape backing. The release liner includes a release surface which can be a release coating (e.g., a silicone, fluorochemical, or carbamate coating) on the paper backing or polymeric film. A release liner is useful for protecting an adhesive surface before it is applied to the surface of the component. In embodiments in which the adhesive tape is a double-sided tape, the adhesive tape may have two release liners.

In some embodiments, the adhesive strips are strips from an adhesive transfer tape. In these embodiments, the method may include removing at least one of a release liner or backing before applying at least one of heat and pressure to the adhesive tape. After removing at least one of a release liner or backing from the transfer tape, the resulting assembly may no longer include the tape backing. In these embodiments, applying at least one of heat or pressure to the separate strips can result in a single, continuous layer of crosslinked adhesive, with no gaps between the adhesive strips.

The separate adhesive strips in the methods and components according to the present disclosure can be applied to an individual component, for example in a membrane electrode assembly as shown in FIG. 5. The separate adhesive strips may also be applied to a fuel cell roll good subassembly having a plurality of individual electrolyte membranes. Sets of separate adhesive strips can be attached to the individual electrolyte membranes in the roll. Each of the sets of the separate adhesive strips can be attached to the peripheral portion of an individual electrolyte membrane in an arrangement that allows the center regions of the individual electrolyte membranes to be exposed. Second sets of separate adhesive strips can be attached to the individual electrolyte membranes in the roll on a side opposite the first set of separate adhesive strips, for example. Each of the second set of separate strips is arranged on peripheral portion of the individual electrolyte membranes on the opposite side so that second surfaces of the center regions of the individual electrolyte membranes are exposed. Individual electrolyte membranes with attached adhesive strips may then be cut from the roll.

In some embodiments of the method and components according to the present disclosure, wherein the component is an electrolyte membrane, the separate adhesive strips collectively form a first subgasket on a first peripheral surface of the electrolyte membrane. In some embodiments, the membrane electrode assembly further includes a second set of separate adhesive strips having first surfaces adhered to an opposing second peripheral surface of the electrolyte membrane to surround the interior portion. A short side of a fifth adhesive strip is positioned adjacent a sixth adhesive strip, for example. When crosslinked, adhesive comprising a crosslinked amorphous fluoropolymer disposed on the first surfaces of the second set of separate strips of the tape backing seals any gaps between the second set of separate adhesive strips and adheres the second set of separate adhesive strips to the opposing second peripheral surface of the electrolyte membrane. In other embodiments, useful assemblies may have only one set of separate adhesive strips collectively forming a single subgasket.

Any electrolyte membrane, suitable for use in a fuel cell, flow battery, or other electrochemical cell, may be used in the practice of the present disclosure. Copolymers of tetrafluoroethylene (TFE) and a co-monomer according to the formula HSO₃—CF₂—CF₂—O—CF(CF₃)—CF₂—O—CF═CF₂ are known and sold under the trade name NAFION® by DuPont Chemical Company, Wilmington, Del. NAFION® copolymer is commonly used in making polymer electrolyte membranes for use in fuel cells. Copolymers of tetrafluoroethylene (TFE) and a co-monomer according to the formula FSO₂—CF₂—CF₂—O—CF═CF₂ and/or FSO₂—CF₂CF₂CF₂CF₂—O—CF═CF₂ are also known and used in sulfonic acid form, i.e., with the FSO₂— end group hydrolyzed to HSO₃— for making polymer electrolyte membranes for use in fuel cells. For fuel cells, useful PEM thicknesses can range between about 200 micrometers and about 1 micrometer.

In some embodiments, membrane electrode assemblies described herein include catalyst layers. Catalyst layers may comprise Pt or Pt alloys coated onto larger carbon particles by wet chemical methods, such as reduction of chloroplatinc acid. This form of catalyst is dispersed with ionomeric binders and/or solvents to form an ink, paste, or dispersion that is applied either to the membrane, a release liner, or current collector.

In some embodiments, the catalyst layers may comprise nanostructured support elements bearing particles or nanostructured thin films (NSTF) of catalytic material. Nanostructured catalyst layers generally do not contain carbon particles as supports and therefore may be incorporated into very thin surface layers of the electrolyte membrane forming a dense distribution of catalyst particles. The use of nanostructured thin film (NSTF) catalyst layers can provide much higher catalyst utilization than catalyst layers formed by dispersion methods and can typically offer more resistance to corrosion at high potentials and temperatures due to the absence of carbon supports. In some implementations, the catalyst surface area of a CCM may be further enhanced by using an electrolyte membrane having microstructured features. NSTF catalyst layers comprise elongated nanoscopic particles that may be formed by vacuum deposition of catalyst materials on to acicular nanostructured supports. Suitable nanostructured supports may comprise whiskers of organic pigment, such as C.I. PIGMENT RED 149 (perylene red). The crystalline whiskers can have substantially uniform but not identical cross-sections, and high length-to-width ratios. The nanostructured support whiskers are coated with coating materials suitable for catalysis, and which endow the whiskers with a fine nanoscopic surface structure capable of acting as multiple catalytic sites. In certain implementations, the nanostructured support whiskers may be extended through continued screw dislocation growth. Lengthening the nanostructured support elements allows for an increased surface area for catalysis.

The nanostructured support whiskers are coated with a catalyst material to form a nanostructured thin film catalyst layer. According to one implementation, the catalyst material comprises a metal, such as a platinum group metal. In one embodiment, the catalyst coated nanostructured support elements may be transferred to a surface of an electrolyte membrane to form a catalyst coated membrane. In another embodiment, the catalyst coated nanostructured support elements may be formed on a GDL surface.

Any suitable current collector (also described as a fluid transport layer, or FTL, or GDL in various applications) may be used in the practice of the present disclosure. A current collectors may have one or more of the following functions: 1) maximizing the electrical contact with electrodes thereby minimizing the resistivity due to long transverse paths of current in the electrodes, 2) serving as the electrode itself (e.g., for some flow batteries), 3) lowering resistance with contact with the backing plates, 4) transferring heat from an MEA to backing plates, 5) allowing flow of reactants (fuel and oxidant, or reductant and oxidant) with minimal pressure drop and uniform distribution of reactants on the surface of an MEA, and 6) allowing easy removal of reaction products, such as water. To serve these functions current collectors are typically electrically conductive and porous. Desirably, materials for current collectors are selected to be electrochemically stable under the reaction conditions of the electrochemical cell.

In some embodiments, current collectors useful as components in membrane electrode assemblies and methods according to the present disclosure can be any material capable of collecting electrical current from the electrode while allowing reactant gasses to pass through, typically a woven or non-woven carbon fiber paper or cloth. In fuel cells, current collectors (GDLs) provide porous access of gaseous reactants and water vapor to the catalyst and membrane, and also collect the electronic current generated in the catalyst layer for powering the external load.

The current collector in the components and methods described herein may include a microporous layer (MPL) and an electrode backing layer (EBL), where the MPL is disposed between the catalyst layer and the EBL. EBLs may be any suitable electrically conductive porous substrate, such as carbon fiber constructions (e.g., woven and non-woven carbon fiber constructions). Examples of commercially available carbon fiber constructions include trade designated “AvCarb P50” carbon fiber paper from Ballard Material Products, Lowell, Mass.; “Toray” carbon paper which may be obtained from ElectroChem, Inc., Woburn, Mass. EBLs may also be treated to increase or impart hydrophobic properties. For example, EBLs may be treated with highly-fluorinated polymers, such as polytetrafluoroethylene (PTFE) and fluorinated ethylene propylene (FEP).

The carbon fiber constructions of EBLs generally have coarse and porous surfaces, which exhibit low bonding adhesion with catalyst layers. To increase the bonding adhesion, the microporous layer may be coated to the surface of EBLs. This smoothens the coarse and porous surfaces of EBLs, which provides enhanced bonding adhesion with some types of catalyst layers.

The method according to the present disclosure and the component according to the present disclosure can be useful in electrochemical devices other than fuel cells, for example, an electrolysis cell, which uses electricity to produce chemical changes or chemical energy. Electrolysis cells are also called electrolyzers. An example of an electrolysis cell is a chlor-alkali membrane cell where aqueous sodium chloride is electrolyzed by an electric current between an anode and a cathode. The electrolyte is separated into an anolyte portion and a catholyte portion by a membrane subject to harsh conditions. In chlor-alkali membrane cells, caustic sodium hydroxide collects in the catholyte portion, hydrogen gas is evolved at the cathode portion, and chlorine gas is evolved from the sodium chloride-rich anolyte portion at the anode. Separate adhesive strips can be applied to chlor-alkali membranes in some embodiments of the methods and assemblies disclosed herein.

The method according to the present disclosure can also be useful for flow batteries (e.g., vanadium redox flow battery or a zinc-bromine flow battery). A flow battery typically uses electrolyte liquids pumped from separate tanks past a membrane between two electrodes. The electrolyte solutions are typically acidic and made with 2M to 5M sulfuric acid.

The method according to the present disclosure may also be useful for an electrode in other electrochemical cells (for example, lithium ion batteries). To make electrodes, powdered active ingredients can be dispersed in a solvent with a polymer binder and coated onto a metal foil substrate, or current collector. The resulting composite electrode contains the powdered active ingredient in the polymer binder adhered to the metal substrate. Useful active materials for making negative electrodes include alloys of main group elements and conductive powders such as graphite. Example of useful active materials for making a negative electrode include oxides (tin oxide), carbon compounds (e.g., artificial graphite, natural graphite, soil black lead, expanded graphite, and scaly graphite), silicon carbide compounds, silicon-oxide compounds, titanium sulfides, and boron carbide compounds. Useful active materials for making positive electrodes include lithium compounds, such as Li_{4/3}Ti_{5/3}O₄, LiV₃O₈, LiV₂O₅, LiCo_{0.2}Ni_{0.8}O₂, LiNiO₂, LiFePO₄, LiMnPO₄, LiCoPO₄, LiMn₂O₄, and LiCoO₂. The electrodes can also include electrically conductive diluents and adhesion promoters.

The separate adhesive strips disclosed herein can be useful, for example, to fill voids in, coat, adhere to, seal, and protect various substrates from chemical permeation, corrosion, and abrasion, for example. In addition to fuel cell assemblies and subassemblies, the method according to the present disclosure can be useful, for example, for hard disk drive assemblies, semiconductor devices, electrolyzers, battery electrode assemblies, and for bonding fluoroelastomer gaskets, for example, to metal in various applications.

### Some Embodiments of the Disclosure

In a first embodiment, the present disclosure provides a method of making an assembly, the method comprising:

providing a component of an assembly having an interior portion and a peripheral portion;

adhering separate strips of an adhesive tape to the peripheral portion of the component to surround the interior portion, wherein a short side of a first strip is positioned adjacent a second strip, wherein the adhesive tape comprises an adhesive disposed on a backing, and wherein the adhesive comprises an amorphous fluoropolymer; and

applying at least one of heat or pressure to the separate strips of the adhesive tape such that the adhesive seals any gap between the first and second strips and crosslinks None of the separate strips individually can surround the interior portion.

In a second embodiment, the present disclosure provides the method of the first embodiment, wherein the adhesive is a transfer tape, the method further comprising removing the backing before applying heat and pressure to the separate strips.

In a third embodiment, the present disclosure provides the method of the first or second embodiment, wherein there are at least three (or four) of the separate strips of the adhesive tape adhered to the peripheral portion of the component to surround the interior portion, wherein each one of the at least three (or four) separate strips is adjacent two other of the at least three (or four) separate strips, and wherein applying at least one of heat or pressure to the separate strips of the adhesive tape seals any gaps between the separate strips of the adhesive tape.

In a fourth embodiment, the present disclosure provides the method of any one of the first to third embodiments, wherein the amorphous fluoropolymer comprises a bromo- or iodo-cure site.

In a fifth embodiment, the present disclosure provides the method of any one of the first to fourth embodiments, wherein the adhesive further comprises a crosslinker.

In a sixth embodiment, the present disclosure provides the method of the fifth embodiment, wherein the crosslinker comprises at least one of tri(methyl)allyl isocyanurate, triallyl isocyanurate, tri(methyl)allyl cyanurate, poly-triallyl isocyanurate, xylylene-bis(diallyl isocyanurate), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, or CH₂═CH—Rₙ—CH═CH₂ wherein R_{f1} is a perfluoroalkylene having from 1 to 8 carbon atoms.

In a seventh embodiment, the present disclosure provides the method of any one of the first to sixth embodiments, wherein the adhesive further comprises a peroxide.

In an eighth embodiment, the present disclosure provides the method of the seventh embodiment, wherein the peroxide is an acyl peroxide or a diacyl peroxide.

In a ninth embodiment, the present disclosure provides the method of any one of the first to eighth embodiments, wherein the assembly is a membrane electrode assembly, and wherein the component comprises at least one of an electrolyte membrane or a current collector.

In a tenth embodiment, the present disclosure provides a component of a membrane electrode assembly, the component comprising:

at least one of an electrolyte membrane or a current collector having an interior portion and a peripheral portion; and

separate strips of a tape backing having first surfaces adhered to the peripheral portion of the component to surround the interior portion,

wherein a short side of a first strip of the tape backing is positioned adjacent a second strip of the tape backing, wherein an adhesive disposed on the first surfaces of the separate strips of the tape backing seals a gap between the first and second strips of the tape backing and adheres the separate strips to the peripheral portion of the component, and wherein the adhesive comprises a crosslinked amorphous fluoropolymer. None of the separate strips individually can surround the interior portion.

In an eleventh embodiment, the present disclosure provides the membrane electrode assembly component of the tenth embodiment, wherein there are at least three (or four) of the separate strips of the tape backing adhered to the peripheral portion of the component to surround the interior portion, wherein each one of the at least three (or four) separate strips is adjacent two other of the at least three (or four) separate strips, and wherein the adhesive disposed on the first surfaces of the separate strips of the tape backing seals gaps between the separate strips of the tape backing.

In a twelfth embodiment, the present disclosure provides the membrane electrode assembly component of the tenth or eleventh embodiment, wherein the crosslinked amorphous fluoropolymer is a peroxide-crosslinked amorphous fluoropolymer.

In a thirteenth embodiment, the present disclosure provides the method or membrane electrode assembly component of any one of the first or third to twelfth embodiments, wherein the adhesive tape is a single-sided adhesive tape.

In a fourteenth embodiment, the present disclosure provides the method or membrane electrode assembly component of any one of the first or third to twelfth embodiments, wherein the adhesive tape has the adhesive disposed on two opposing surfaces of the backing.

In a fifteenth embodiment, the present disclosure provides the method or membrane electrode assembly component of any one of the first or third to fourteenth embodiments, wherein the tape backing comprises at least one of a polyamide, a polycarbonate, a modified polyphenylene ether, a polyester, a fluoroplastic, polyphenylene sulfide, poly sulfone, polyarylate, polyetherimide, polyimide, polyethersulfone, polyether ketone, or polystyrene.

In a sixteenth embodiment, the present disclosure provides the method or membrane electrode assembly component of any one of the first to fifteenth embodiments, wherein the adhesive further comprises a plasticizer.

In a seventeenth embodiment, the present disclosure provides the method or membrane electrode assembly component of the sixteenth embodiment, wherein the plasticizer comprises an ionic liquid having an anion and a cation.

In an eighteenth embodiment, the present disclosure provides the method or membrane electrode assembly component of the seventeenth embodiment, wherein the cation of the ionic liquid is selected from N-ethyl-N′-methylimidazolium N-methyl-N-propylpiperidinium, N,N,N-trimethyl-N-propylammonium, N-methyl-N,N,N-tripropylammonium, N,N,N-trimethyl-N-butylammoniuim, N,N,N-trimethyl-N-methoxyethylammonium, N-methyl-N,N,N-tris(methoxyethyl)ammonium, N-methyl-N,N,N-tributylammonium, N,N,N-trimethyl-N-hexylammonium, N,N-diethyl-N-methyl-N-(2-methoxyethyl)ammonium, 1-propyl-tetrahydrothiophenium, 1-butyl-tetrahydrothiophenium, glycidyltrimethylammonium, N-ethyl-N-methylmorphonium, N,N,N-trioctylammonium, N-methyl-N,N,N-trioctylammonium, N-methyl-N,N,N-tributylammonium, N,N-dimethyl-N-octyl-N-(2-hydroxyethyl)ammonium, and a combination thereof.

In a nineteenth embodiment, the present disclosure provides the method or membrane electrode assembly component of the seventeenth or eighteenth embodiment, wherein the anion of the ionic liquid is selected from bis(trifluoromethanesulfonyl) imide, bis(pentafluoroethanesulfonyl)imide, bis(heptafluoropropanesulfonyl)imide, bis(nonafluorobutanesulfonyl)imide, trifluoromethanesulfonate, pentafluoroethanesulfonate, heptafluoropropanesulfonate, nonafluorobutanesulfonate, tris(trifluoromethanesulfonyl)methide, tris(pentafluoroethanesulfonyl)methide, tris(heptafluoropropanesulfonyl)methide, tris(nonafluorobutanesulfonyl)methide, and a combination thereof.

In a twentieth embodiment, the present disclosure provides the method or membrane electrode assembly component of any one of the first to nineteenth embodiments, wherein the interior portion of the component has a surface area of at least 500 cm².

In a twenty-first embodiment, the present disclosure provides the method or membrane electrode assembly component of any one of the first to twentieth embodiments, wherein the component is an electrolyte membrane, and wherein the separate strips of the tape backing collectively form a first subgasket on a first peripheral surface of the electrolyte membrane.

In a twenty-second embodiment, the present disclosure provides the method or membrane electrode assembly component of the twenty-first embodiment, wherein the electrolyte membrane further comprises a second set of separate strips of the tape backing having first surfaces adhered to an opposing second peripheral surface of the electrolyte membrane to surround the interior portion, wherein a short side of a fifth strip of the tape backing is positioned adjacent a sixth strip of the tape backing, wherein adhesive comprising a crosslinked amorphous fluoropolymer disposed on the first surfaces of the second set of separate strips of the tape backing seals a gap between the fifth and sixth strips of the tape backing and adheres the second set of separate strips to the opposing second peripheral surface of the electrolyte membrane.

In a twenty-third embodiment, the present disclosure provides the method or membrane electrode assembly component of any one of the first to twentieth embodiments, wherein the component is an electrolyte membrane.

In a twenty-fourth embodiment, the present disclosure provides the method or membrane electrode assembly component of any one of the first to twenty-third embodiments, wherein the component is a catalyst coated membrane.

In a twenty-fifth embodiment, the present disclosure provides the method or membrane electrode assembly component of any one of the first to twentieth embodiments, wherein the component is a current collector.

In a twenty-sixth embodiment, the present disclosure provides the method or membrane electrode assembly component of any one of the first to twentieth embodiments, wherein the component is a catalyst coated current collector.

In a twenty-seventh embodiment, the present disclosure provides an electrochemical cell comprising the membrane electrode assembly component of or made by the method of any one of the first to twenty-sixth embodiments.

In a twenty-eighth embodiment, the present disclosure provides a fuel cell comprising the membrane electrode assembly component of or made by the method of any one of the first to twenty-sixth embodiments.

In a twenty-ninth embodiment, the present disclosure provides a flow battery comprising the membrane electrode assembly component of or made by the method of any one of the first to twenty-sixth embodiments.

In a thirtieth embodiment, the present disclosure provides a component of a membrane electrode assembly, the component comprising:

at least one of an electrolyte membrane or a current collector having an interior portion and a peripheral portion; and

separate adhesive strips disposed on the peripheral portion of the component to surround the interior portion, wherein a short side of a first adhesive strip is positioned adjacent a second adhesive strip;

wherein each of the separate adhesive strips comprises an adhesive comprising an amorphous fluoropolymer. None of the separate strips individually can surround the interior portion.

In a thirty-first embodiment, the present disclosure provides the component of the thirtieth embodiment, wherein there are at least three or four of the separate adhesive strips disposed on the peripheral portion of the component to surround the interior portion, wherein each one of the at least three or four separate adhesive strips is adjacent two other of the at least three or four separate adhesive strips.

In a thirty-second embodiment, the present disclosure provides the component of the thirtieth or thirty-first embodiment, wherein the interior portion of the component has a surface area of at least 500 cm².

In a thirty-third embodiment, the present disclosure provides the component any one of the thirtieth to thirty-second embodiments, wherein the separate adhesive strips each comprise the adhesive disposed on a tape backing.

In a thirty-fourth embodiment, the present disclosure provides the component of the thirty-third embodiment, wherein the separate adhesive strips each comprise a single-sided adhesive tape.

In a thirty-fifth embodiment, the present disclosure provides the component of the thirty-third embodiment, wherein the separate adhesive strips each comprise the adhesive disposed on two opposing surfaces of the backing.

In a thirty-sixth embodiment, the present disclosure provides the component of the thirty-fourth or thirty-fifth embodiment, wherein the tape backing comprises at least one of a polyamide, a polycarbonate, a modified polyphenylene ether, a polyester, a fluoroplastic, polyphenylene sulfide, polysulfone, polyarylate, polyetherimide, polyimide, polyethersulfone, polyether ketone, or polystyrene.

In a thirty-seventh embodiment, the present disclosure provides the component of any one of the thirtieth to thirty-sixth embodiments, wherein the amorphous fluoropolymer comprises a bromo- or iodo-cure site.

In a thirty-eighth embodiment, the present disclosure provides the component of any one of the thirtieth to thirty-seventh embodiments, wherein the adhesive further comprises a crosslinker.

In a thirty-ninth embodiment, the present disclosure provides the component of the thirty-eighth embodiment, wherein the crosslinker comprises at least one of tri(methyl)allyl isocyanurate, triallyl isocyanurate, tri(methyl)allyl cyanurate, poly-triallyl isocyanurate, xylylene-bis(diallyl isocyanurate), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, or CH₂═CH—R_{f1}—CH═CH₂ wherein R_{f1} is a perfluoroalkylene having from 1 to 8 carbon atoms.

In a fortieth embodiment, the present disclosure provides the component of any one of the thirtieth to thirty-ninth embodiments, wherein the adhesive further comprises a peroxide.

In a forty-first embodiment, the present disclosure provides the component of the fortieth embodiment, wherein the peroxide is an acyl peroxide or a diacyl peroxide.

In a forty-second embodiment, the present disclosure provides the component of any one of the thirtieth to forty-first embodiments, wherein the adhesive further comprises a plasticizer.

In a forty-third embodiment, the present disclosure provides the component of the forty-second embodiment, wherein the plasticizer comprises an ionic liquid having an anion and a cation.

In a forty-fourth embodiment, the present disclosure provides the component of the forty-third embodiment, wherein the cation of the ionic liquid is selected from N-ethyl-N′-methylimidazolium N-methyl-N-propylpiperidinium, N,N,N-trimethyl-N-propylammonium, N-methyl-N,N,N-tripropylammonium, N,N,N-trimethyl-N-butylammoniuim, N,N,N-trimethyl-N-methoxyethylammonium, N-methyl-N,N,N-tris(methoxyethyl)ammonium, N-methyl-N,N,N-tributylammonium, N,N,N-trimethyl-N-hexylammonium, N,N-diethyl-N-methyl-N-(2-methoxyethyl)ammonium, 1-propyl-tetrahydrothiophenium, 1-butyl-tetrahydrothiophenium, glycidyltrimethylammonium, N-ethyl-N-methylmorphonium, N,N,N-trioctylammonium, N-methyl-N,N,N-trioctylammonium, N-methyl-N,N,N-tributylammonium, N,N-dimethyl-N-octyl-N-(2-hydroxyethyl)ammonium, and a combination thereof.

In a forty-fifth embodiment, the present disclosure provides the component of the forty-third or forty-fourth embodiment, wherein the anion of the ionic liquid is selected from bis(trifluoromethanesulfonyl) imide, bis(pentafluoroethanesulfonyl)imide, bis(heptafluoropropanesulfonyl)imide, bis(nonafluorobutanesulfonyl)imide, trifluoromethanesulfonate, pentafluoroethanesulfonate, heptafluoropropanesulfonate, nonafluorobutanesulfonate, tris(trifluoromethanesulfonyl)methide, tris(pentafluoroethanesulfonyl)methide, tris(heptafluoropropanesulfonyl)methide, tris(nonafluorobutanesulfonyl)methide, and a combination thereof.

In a forty-sixth embodiment, the present disclosure provides the component of any one of the thirtieth to forty-fifth embodiments, wherein the component is an electrolyte membrane.

In a forty-seventh embodiment, the present disclosure provides the component of any one of the thirtieth to forty-fifth embodiments, wherein the component is a catalyst coated membrane.

In a forty-eighth embodiment, the present disclosure provides the component of any one of the thirtieth to forty-fifth embodiments, wherein the component is a current collector.

In a forty-ninth embodiment, the present disclosure provides the component of any one of the thirtieth to forty-fifth embodiments, wherein the component is a catalyst coated current collector.

In a fiftieth embodiment, the present disclosure provides an electrochemical cell comprising the component of any one of the thirtieth to forty-ninth embodiments.

In a fifty-first embodiment, the present disclosure provides a fuel cell comprising the component of any one of the thirtieth to forty-ninth embodiments.

In a fifty-second embodiment, the present disclosure provides a flow battery comprising the component of any one of the thirtieth to forty-ninth embodiments.

The following specific, but non-limiting, examples will serve to illustrate the present disclosure.

### Examples

The following abbreviations are used in this section: min=minutes, m=meters, cm=centimeters, mm=millimeters, in=inches, kPa=kilopascals, kg=kilograms, psi=pounds per square inch, N=newtons.

### Materials

TABLE 1
Materials Used in Examples

| Acronym | Description |
|---|---|
| CIPG 1951 | A cure-in-place adhesive strip with PTFE |
| | backing and fluoroelastomer adhesive, |
| | available under the trade designation, |
| | “3M ™ DYNEON ™ CIPG 1951” from |
| | 3M Company, St. Paul, MN. |
| KAPTON ® | Polyimide film obtained under the trade |
| | designation “KAPTON HN” from |
| | E. I. du Pont de Nemours and Company |

### Gasket Characterization

### Pressure Testing

Sealing performance of gaskets was measured using compressed air. The testing apparatus included two square, aluminum plates of thickness 1.27 cm (0.5 in.) and with 100 mm edges. The center of one square plate was pierced by a threaded hole allowing connection of the plate to a compressed air supply. Centered on the pierced plate was a die-cut elastomer seal, the gasket of an example or counter example laminated to a square piece of KAPTON® film with 101.6 mm (4 in) edges, and the other square plate. The laminated film was placed between the elastomer and aluminum plate, with the tape contacting both the KAPTON® film and the elastomer. Four bolts fastened through holes near the four corners of both plates were used to apply pressure to the seal, gasket, and film by tightening the bolts using a torque wrench applying 6.8 N-m (60 inch-pound) of torque. After air pressure of 280 kPa was applied using a gas pressure regulator, a valve between the compressed air source and the regulator was closed and the pressure on the apparatus side of the regulator was recorded over time.

### Peel Strength

Peel strength was measured using an INSTRON® Model 1125 Tester, available from Instron Corp., Norwood, Mass., Samples on KAPTON® substrates were measured in accordance with ASTM D1876-01 with the following deviations, and samples on stainless steel substrates were measured in accordance with ASTM D3330/D3330M, Method A, with the following deviations:
crosshead speed was set at a 300 mm/min
the samples had width of 25.4 mm
the peel strength of the middle 60% of the adhered length of the sample (15.2 cm) was measured (values from the peel of the first 20% and the last 20% of the adhered length were omitted)
after application of samples to substrate, samples were manually rolled over using a 2 kg hand roller for four passes after removing the release liner from the samples
after rolling, test specimens were either cured with heat and pressure at 130° C. and 275 kPa (40 psi) for 3 min and allowed to cool to room temperature before testing, or tested immediately
The value reported is an average of determinations for three samples

### Example 1 (EX-1)

The gasket was made from 25.4 mm wide adhesive strips cut to 76.2 mm (3 in) lengths. The strips were arranged on a piece of KAPTON® film, with the adhesive side of each strip facing the film, in the arrangement shown in FIG. 2. The gasket was cured with heat and pressure of 130° C. and 275 kPa (40 psi) applied for 3 min using a heat press (obtained from Wabash MPI, Wabash, Ind.). After cooling to room temperature, the gasket was pressure tested. The results of the pressure test are summarized in Table 2, below.

### Illustrative Example 1 (IE-1)

A gasket was made and tested as in EX-1 except the gasket was die-cut from adhesive strips made in the same way as CIPG 1951 but not cut to 25.4 mm wide strips. The die-cut gasket had a square perimeter with 101.6 mm (4 in) sides and a square of material with 50.8 mm (2 in) sides removed from the center, centered within the perimeter. The results of the pressure test are summarized in Table 2.

### Illustrative Example 2 (IE-2)

The gasket was made as described for EX-1, except that the gasket was not cured with heat and pressure. The results of the pressure test are summarized in Table 2.

### Illustrative Example 3 (IE-3)

The gasket was made as described for IE-1, except that the gasket was not cured with heat and pressure. The results of the pressure test are summarized in Table 2.

TABLE 2
Pressure Decay

Pressure (kPa)

| | EX-1 | IE-1 | IE-2 | IE-3 |
|---|---|---|---|---|
| | Strips, | Die Cut, | Strips, | Die Cut, |
| Time (sec) | Cured | Cured | Uncured | Uncured |
| 0 | 276 | 276 | 276 | 276 |
| 8 | NM | NM | 262 | NM |
| 16 | NM | NM | 242 | NM |
| 28 | NM | NM | 221 | NM |
| 40 | NM | NM | 207 | NM |
| 52 | NM | NM | 193 | NM |
| 60 | 276 | 276 | NM | 276 |
| 70 | NM | NM | 179 | NM |
| 85 | NM | NM | 173 | NM |
| 109 | NM | NM | 166 | NM |
| 120 | 276 | 276 | NM | 276 |
| 138 | NM | NM | 159 | NM |
| 179 | NM | NM | 152 | NM |
| 238 | NM | NM | 145 | NM |
| 240 | 276 | 276 | NM | 276 |
| 400 | 276 | 276 | 138 | 276 |
| 500 | 276 | 276 | NM | 276 |

NM = not measured

### Example 2 (EX-2)

Peel strength was measured for strips of CIPG 1951 adhered to a KAPTON® substrate and cured prior to testing. The peel strength is reported in Table 3, below.

### Example 3 (EX-3)

Peel strength was measured for strips of CIPG 1951 adhered to a stainless steel substrate and cured prior to testing. The peel strength is reported in Table 3.

### Illustrative Example 4 (IE-4)

Peel strength was measured as described for EX-2, except that the strips of CIPG 1951 were not cured prior to testing. The peel strength is reported in Table 3.

### Illustrative Example 5 (IE-5)

Peel strength was measured as described for EX-3, except that the strips of CIPG 1951 were not cured prior to testing. The peel strength is reported in Table 3.

TABLE 3
Peel Strength

| Example or Counter Example | Substrate | Peel Strength (N/cm) |
|---|---|---|
| EX-2 | KAPTON ® | 5.8 |
| EX-3 | Stainless Steel | 5.3 |
| IE-4 | KAPTON ® | 0.4 |
| IE-5 | Stainless Steel | 0.2 |

Various modifications and alterations of this disclosure may be made by those skilled the art without departing from the scope and spirit of the disclosure, and it should be understood that this invention is not to be unduly limited to the illustrative embodiments set forth herein.

1. A method of making an assembly, the method comprising:
providing a component of an assembly having an interior portion and a peripheral portion;
adhering separate strips of an adhesive tape to the peripheral portion of the component to surround the interior portion, wherein a short side of a first strip is positioned adjacent a second strip, wherein the adhesive tape comprises an adhesive disposed on a backing, and wherein the adhesive comprises an amorphous fluoropolymer; and
applying at least one of heat or pressure to the separate strips of the adhesive tape such that the adhesive seals any gap between the first and second strips and crosslinks.

2. The method of claim 1, wherein the adhesive tape has the adhesive disposed on one surface of the backing.

3. The method of claim 1, wherein the adhesive tape has the adhesive disposed on two opposing surfaces of the backing.

4. The method of claim 1, wherein there are at least three of the separate strips of the adhesive tape adhered to the peripheral portion of the component to surround the interior portion, wherein each one of the at least three separate strips is adjacent two other of the at least three separate strips, and wherein applying at least one of heat or pressure to the separate strips of the adhesive tape seals any gaps between the separate strips of the adhesive tape.

5. The method of claim 1, wherein the amorphous fluoropolymer comprises a bromo- or iodo-cure site, and wherein the adhesive further comprises a peroxide.

6. The method of claim 1, wherein the assembly is a membrane electrode assembly, and wherein the component comprises at least one of an electrolyte membrane or a current collector.

7. An electrochemical cell made by the method of claim 6.

8. A component of a membrane electrode assembly, the component comprising:
at least one of an electrolyte membrane or a current collector having an interior portion and a peripheral portion; and
separate strips of a tape backing having first surfaces adhered to the peripheral portion of the component to surround the interior portion,
wherein a short side of a first strip of the tape backing is positioned adjacent a second strip of the tape backing, wherein an adhesive disposed on the first surfaces of the separate strips of the tape backing seals a gap between the first and second strips of the tape backing and adheres the separate strips to the peripheral portion of the component, and wherein the adhesive comprises a crosslinked amorphous fluoropolymer.

9. The membrane electrode assembly component of claim 8, wherein there are at least three of the separate strips of the tape backing adhered to the peripheral portion of the component to surround the interior portion, wherein each one of the at least three separate strips is adjacent two other of the at least three separate strips, and wherein the adhesive disposed on the first surfaces of the separate strips of the tape backing seals any gaps between the separate strips of the tape backing.

10. The membrane electrode assembly component of claim 8 or 9, wherein the adhesive further comprises a plasticizer.

11. The membrane electrode assembly component of claim 10, wherein the plasticizer comprises an ionic liquid.

12. The membrane electrode assembly component of claim 8, wherein the component is an electrolyte membrane, and wherein the separate strips of the tape backing collectively form a first subgasket on a first peripheral surface of the electrolyte membrane.

13. The membrane electrode assembly component of claim 8, wherein the component is a catalyst coated electrolyte membrane.

14. The membrane electrode assembly component of claim 8, wherein the interior portion of the component has a surface area of at least 500 cm².

15. An electrochemical cell comprising the membrane electrode assembly component of claim 8.

16. A component of a membrane electrode assembly, the component comprising:
at least one of an electrolyte membrane or a current collector having an interior portion and a peripheral portion; and
separate adhesive strips disposed on the peripheral portion of the component to surround the interior portion, wherein a short side of a first adhesive strip is positioned adjacent a second adhesive strip;
wherein each of the separate adhesive strips comprises an adhesive comprising an amorphous fluoropolymer.

17. The component of claim 16, wherein there are at least three of the separate adhesive strips disposed on the peripheral portion of the component to surround the interior portion, wherein each one of the at least three separate adhesive strips is adjacent two other of the at least three separate adhesive strips.

18. The component of claim 16, wherein the separate adhesive strips each comprise the adhesive disposed on a tape backing.

19. The component of claim 16, wherein the separate adhesive strips each comprise the adhesive disposed on two opposing surfaces of the backing.

20. The component of claim 16, wherein the amorphous fluoropolymer comprises a bromo- or iodo-cure site.
